(19) United States
(12) Patent Application Publication
(10) Pub. No.: US 2025/0199838 A1
(43) Pub. Date: Jun. 19, 2025

(54) System and Method for Computation Workload Processing

(71) Applicant: DataPelago, Inc., Mountain View, CA (US)

(72) Inventors: Satyanarayana Lakshmipathi Billa, Sunnyvale, CA (US); Rajan Goyal, Saratoga, CA (US); Abhishek Kumar Dikshit, San Jose, CA (US)

(21) Appl. No.: 18/541,993

(22) Filed: Dec. 15, 2023

(51) Int. Cl. G06F 9/455

(52) U.S. Cl. CPC G06F 9/45558; G06F 2009/45575; G06F 2009/45587

(57) ABSTRACT

A computer-based system and corresponding computer-implemented method process computation workloads to enable advanced functionality for data analytics. An execution resource is selected from a set of execution resources of a virtual machine (VM). The resource is for executing a VM instruction. The VM instruction is transformed into machine code for the resource selected. The code is executed via the resource selected. The executing furthers execution by the VM of a dataflow graph (DFG) including a compute node. The compute node has a set of VM instructions including the VM instruction. The DFG corresponds to a portion of a computation workload associated with a user data query. An output of the execution of the DFG represents a result of processing the workload and contributes to a response to the query. The system and method enable rapid and efficient retrieval and analysis of data in data storage systems, based on computation workloads.

### RELATED APPLICATIONS

This application is related to U.S. Application No. ______, entitled “System and Method for Input Data Query Processing” (Attorney Docket No.: 6214.1001-000), filed on Dec. 15, 2023, and U.S. Application No. ______, entitled “Programmable Dataflow Unit” (Attorney Docket No.: 6214.1004-000), filed on Dec. 15, 2023. The entire teachings of the above applications are incorporated herein by reference.

### BACKGROUND

A data lake is a repository designed to store and process large amounts of structured and/or unstructured data. Conventional data lakes provide limited real-time or batch processing of stored data and can analyze the data by executing commands issued by a user in SQL (structured query language) or another query or programming language. The exponential growth of computer data storage raises several challenges for storage, retrieval, and analysis of data. In particular, data lakes and other data storage systems have the capacity to store large and ever-increasing quantities of data.

### SUMMARY

According to an example embodiment, a computer-implemented method comprises selecting an execution resource from a set of execution resources of a virtual machine (VM). The execution resource is for executing a VM instruction. The method further comprises transforming the VM instruction into machine code for the execution resource selected. The method further comprises executing the machine code via the execution resource selected. The executing furthers execution by the VM of a dataflow graph that includes at least one compute node. A compute node of the at least one compute node has a set of VM instructions including the VM instruction. The dataflow graph corresponds to at least a portion of a computation workload associated with a user data query. An output of the execution of the dataflow graph: (i) represents a result of processing the at least a portion of the computation workload and (ii) contributes to a response to the user data query.

The selecting may be based on at least one of: (i) a respective efficiency of executing the VM instruction at each execution resource of the set of execution resources and (ii) a respective availability of each execution resource of the set of execution resources.

The VM instruction may be specified in an instruction set architecture (ISA). The ISA may be compatible with at least one type of computation workload. The at least one type of computation workload may include a type of the computation workload associated with the user data query. The at least one type of computation workload may include a Structured Query Language (SQL) query plan, a data ingestion pipeline, an artificial intelligence (AI) or machine learning (ML) workload, a high-performance computing (HPC) program, another type of computation workload, or a combination thereof for non-limiting examples.

Selecting the execution resource may be based on the execution resource including an accelerator.

Selecting the execution resource may be based on the execution resource including a programmable dataflow unit (PDU) based accelerator, a graphics processing unit (GPU) based accelerator, a tensor processing core (TPC) based accelerator, a tensor processing unit (TPU) based accelerator, a single instruction multiple data (SIMD) unit based accelerator, a central processing unit (CPU) based accelerator, another type of accelerator, or a combination thereof for non-limiting examples.

The compute node may be a first compute node. The method may further comprise processing, via the first compute node, a first data block associated with the at least a portion of the computation workload. The processing may be performed in parallel with at least one of: (i) processing, via a second compute node of the at least one compute node, a second data block associated with the at least a portion of the computation workload and (ii) transferring, via an edge of a set of edges associated with the dataflow graph. The second data block may be associated with the at least a portion of the computation workload.

The method may further comprise controlling a flow of data blocks between at least two dataflow nodes of the dataflow graph. The at least two dataflow nodes may include the at least one compute node. The data blocks may be (i) associated with the at least a portion of the computation workload and (ii) derived from a data source associated with the user data query.

The method may further comprise performing validation of the dataflow graph. The method may further comprise, responsive to the validation being unsuccessful, terminating execution of the dataflow graph. The method may further comprise, responsive to the validation being successful, proceeding with the execution of the dataflow graph.

The method may further comprise generating a set of edges associated with the dataflow graph. Each edge of the set of edges may be configured to transfer data blocks between a corresponding pair of dataflow nodes of the dataflow graph. The dataflow nodes may include the at least one compute node. The generating may include configuring an edge of the set of edges to transfer the data blocks using a first in first out (FIFO) queue. The method may further comprise configuring, based on a user input, a size of the FIFO queue. The generating may include configuring an edge of the set of edges to synchronize a first processing speed of a first compute node of the at least one compute node with a second processing speed of a second compute node of the at least one compute node.

The executing may include performing at least one of: an input control function, a flow control function, a register control function, an output control function, a reduce function, a map function, a load function, and a generate function for non-limiting examples.

The executing may include executing the VM instruction via a software-based execution unit, a hardware-based execution unit, or a combination thereof for non-limiting examples.

The dataflow graph may include at least one input node. The method may further comprise obtaining, based on an input node of the at least one input node, at least one data block from a data source associated with the user data query. The obtaining may include implementing a read protocol corresponding to the data source.

The dataflow graph may include at least one output node. The method may further comprise storing, based on an output node of the at least one output node, at least one data block to a datastore. The storing may include implementing a write protocol corresponding to the datastore.

The method may further comprise spawning at least one task corresponding to at least one of: (i) the at least one compute node, (ii) at least one input node of the dataflow graph, (iii) at least one output node of the dataflow graph, and (iv) at least one edge associated with the dataflow graph for non-limiting examples. A task of the at least one task spawned may include a thread corresponding to the compute node. The method may further comprise executing the set of VM instructions via the thread. The method may further comprise monitoring execution of a task of the at least one task spawned.

The method may further comprise adapting the set of VM instructions based on at least one statistic associated with the at least a portion of the computation workload. A statistic of the least one statistic may include a runtime statistical distribution of data values in a data source associated with the user data query. The adapting may be responsive to identifying a mismatch between the runtime statistical distribution of the data values and an estimated statistical distribution of the data values. The adapting may include at least one of: (i) reordering at least two VM instructions of the set of VM instructions, (ii) removing at least one VM instruction from the set of VM instructions, (iii) adding at least one VM instruction to the set of VM instructions, and (iv) modifying at least one VM instruction of the set of VM instructions for non-limiting examples.

The method may further comprise generating, based on the dataflow graph, a plurality of dataflow subgraphs. The method may further comprise configuring at least two dataflow subgraphs of the plurality of dataflow subgraphs to, when executed via the VM, perform a data movement operation in parallel. The VM may be a first VM. The data movement operation may include at least one of: (i) streaming data from a data source associated with the user data query and (ii) transferring data to or from a second VM for non-limiting examples.

According to another example embodiment, a computer-based system comprises at least one virtual machine (VM), at least one processor, and a memory with computer code instructions stored thereon. The at least one processor and the memory, with the computer code instructions, are configured to cause a VM of the at least one VM to select an execution resource from a set of execution resources of the VM, the execution resource for executing a VM instruction. The at least one processor and the memory, with the computer code instructions, are further configured to cause the VM of the at least one VM to transform the VM instruction into machine code for the execution resource selected. The at least one processor and the memory, with the computer code instructions, are further configured to cause the VM of the at least one VM to execute the machine code via the execution resource selected to further execution by the VM of a dataflow graph that includes at least one compute node. A compute node of the at least one compute node has a set of VM instructions including the VM instruction. The dataflow graph corresponds to at least a portion of a computation workload associated with a user data query. An output of the execution of the dataflow graph: (i) represents a result of processing the at least a portion of the computation workload and (ii) contributes to a response to the user data query.

Alternative computer-based system embodiments parallel those described above in connection with the above example computer-implemented method embodiment.

According to yet another example embodiment, a computer-implemented method comprises selecting an execution resource from a set of execution resources of a virtual machine (VM). The selecting is performed as part of executing a compute node of at least one compute node of a dataflow graph being executed by the VM. The compute node includes at least one VM instruction. The selecting is performed on an instruction-by-instruction basis. The method further comprises performing, at the compute node on the instruction-by-instruction basis, just-in-time compilation of a VM instruction of the at least one VM instruction. The performing transforms the VM instruction to machine code executable by the execution resource selected. The method further comprises executing the machine code by the execution resource selected. The dataflow graph corresponds to at least a portion of a computation workload associated with a user data query. The executing advances the compute node toward producing a result. The result contributes to production of a response to the user data query.

It is noted that example embodiments of a method and system may be configured to implement any embodiments, or combination of embodiments, described herein.

It should be understood that example embodiments disclosed herein can be implemented in the form of a method, apparatus, system, or computer readable medium with program codes embodied thereon.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a block diagram of an example embodiment of a computer-based system.

FIG. 1B is a block diagram of an example embodiment of a data analytics compute cluster.

FIG. 2 is a block diagram of an example embodiment of a data analytics system.

FIG. 3 is a block diagram of an example embodiment of a multi-cloud analytics platform.

FIG. 4 is a block diagram of an example embodiment of a service console server.

FIG. 5 is a block diagram of an example embodiment of a query server.

FIG. 6 is a flow diagram of an example embodiment of a data analysis process that may be performed by an example embodiment of query server disclosed herein.

FIG. 7 is a block diagram of an example embodiment of a disaggregated data analytics stack with domain-specific computing.

FIG. 8 is a block diagram of an example embodiment of a third phase of a data analytics pipeline.

FIG. 9 is a flow diagram of an example embodiment of a process for a hardware-agnostic domain-specific virtual machine (VM).

FIG. 10 is a block diagram of an example embodiment of mapping machine code of a dataflow graph (DFG) to a Programmable Dataflow Unit (PDU).

FIG. 11 is a block diagram of another example embodiment of mapping machine code of a DFG to a PDU.

FIG. 12 is a block diagram of an example embodiment of an architecture for a computer-based system disclosed herein.

FIG. 13 is a block diagram of an example prior art central processing unit (CPU) in operation.

FIG. 14 is a block diagram of an example embodiment of a PDU in operation.

FIG. 15 is a block diagram of an example prior art control flow process for a prior art CPU.

FIG. 16 is a block diagram of an example embodiment of a dataflow process for a PDU.

FIG. 17 is a block diagram of an example embodiment of a DFG.

FIG. 18 is a block diagram of an example embodiment of a logical structure of an edge.

FIG. 19 is a block diagram of an example embodiment of a compute node.

FIG. 20 is a block diagram of an example embodiment of an execution environment for a compute node.

FIG. 21 is a flow diagram of an example embodiment of a computer-implemented method.

FIG. 22 is a flow diagram of another example embodiment of a computer-implemented method.

FIG. 23 is a block diagram of an example embodiment of an internal structure of a computer optionally within an embodiment disclosed herein.

### DETAILED DESCRIPTION

A description of example embodiments follows.

Embodiments provide advanced functionality for data analytics. As used herein, a “dataflow graph” (DFG) may include a graph or tree data structure where each node in the graph represents a computational operation or task to be performed using data, and each edge in the graph represents a dataflow operation or task, i.e., to move data between nodes. Further, as used herein, a “query front-end” or simply “front-end” may include a client entity or computing device at which a user data query is created, edited, and/or generated for submission. Likewise, as used herein, a “query back-end” or simply “back-end” may include a server entity or computing device that receives a user data query created by a front-end. It should also be understood that, as used herein, numerical adjectives, such as the terms “first” and “second,” do not imply ordering (such as, e.g., chronological or other types of ordering) or cardinality, but instead simply distinguish between two different objects or components of the same type, for instance, two different nodes or data blocks.

Conventional data analytics platforms are constrained in ways that prevent them from meeting the demands of modern data storage, retrieval, and analysis. For example, many existing analytics systems employ general-purpose processors, such as x86 central processing units (CPUs) for non-limiting example, that manage retrieval of data from a database for processing a query. However, such systems often have inadequate bandwidth for retrieving and analyzing large stores of structured and unstructured data, such as those of modern data lakes. Further, the output data resulting from queries of such data stores may be much larger than the input data, placing a bottleneck on system performance. Typical query languages, such as structured query language (SQL) for non-limiting example, can produce inefficient or nonoptimal plans for such systems, leading to delays or missed data. Such plans can also lead to a mismatch between input/output (I/O) and computing load. For example, in a CPU-based analytics system, I/O may be underutilized due to an overload of computation work demanded of the CPU.

The CAP (Consistency, Availability, and Partition Tolerance) theorem states that a distributed data store is capable of providing only two of the following three guarantees:
a) Consistency: Every read operation receives data in accordance with the most recent write operation.
b) Availability: Every request receives a response.
c) Partition tolerance: The system will continue to operate despite experiencing delay or dropping of messages.

Similar to the CAP theorem, existing data stores cannot maximize dataset performance, size, and freshness simultaneously; prioritizing two of these qualities leads to the third being compromised. Thus, prior approaches to data analytics have been limited from deriving cost-efficient and timely insights from large datasets. Attempts to solve this problem have led to complex data pipelines having fragmented data silos.

Example embodiments, described herein, provide data analytics platforms that overcome several of the aforementioned challenges in data analytics. In particular, a query compiler may be configured to generate an optimized DFG from an input query, providing efficient workflow instructions for the platform. PDUs (Programmable Dataflow Units) are hardware engines for executing the input query in accordance with the workflow and may include a number of distinct accelerators that may each be optimized for different operations within the workflow. Such platforms may also match the impedance between computational load and I/O. As a result, data analytics platforms in example embodiments can provide consistent, cost-efficient, and timely insights from large datasets.

According to an example embodiment, a novel virtual machine (VM) platform, referred to interchangeably herein as “Insight” or a computer-based system, accelerates data analytics workloads, and such acceleration may be enabled by, among other things, a programmable dataflow unit (PDU). Unlike traditional VMs, an example embodiment of a VM disclosed herein may take a description of a computation as dataflow graphs (DFGs) and evaluate the DFGs. The DFGs may include nodes and edges. Nodes may perform operations and edges may carry data between nodes. Edges may move data as a stream of data blocks. All the data blocks may be immutable and shared by multiple nodes using reference counts. There may be three different kinds of nodes: input nodes, output nodes and compute nodes. Input nodes may act as data sources and output nodes may act as data sinks. Input nodes may pull data from local or external sources and push the data into the DFG. Output nodes may pull data from a DFG and push the data to local and/or external sinks. Compute nodes may perform various transformations on data, such as filtering, grouping, joining, etc., for non-limiting examples, and may use hardware accelerators on a PDU.

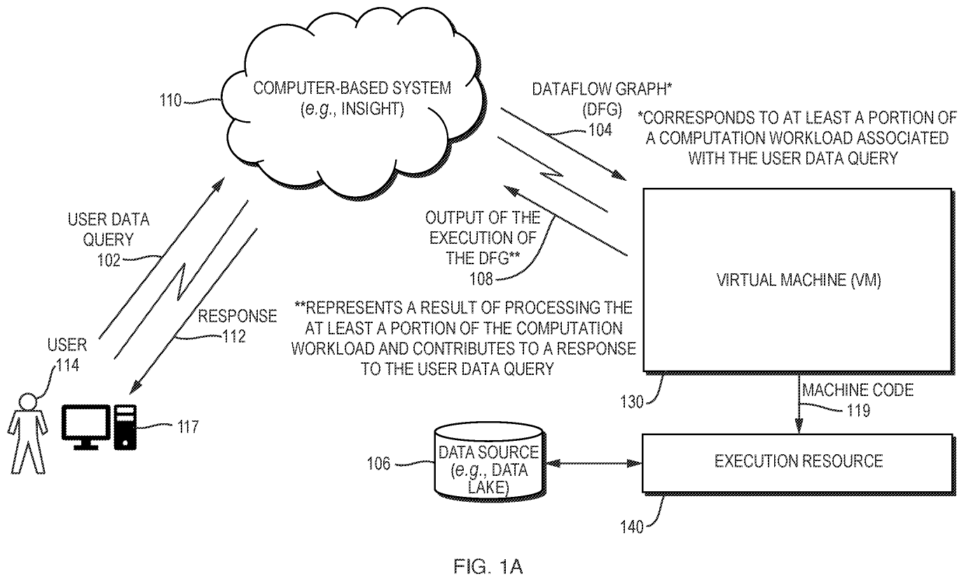

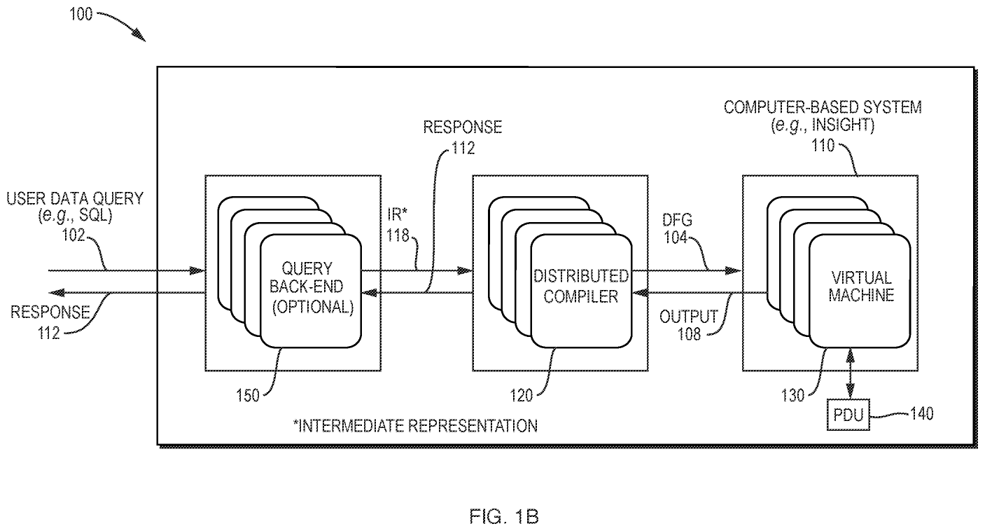

An example embodiment of a VM compute node disclosed herein may be programmable using an instruction set architecture (ISA) that is accelerator-centric. Traditionally, VM instructions are ALU (arithmetic logic unit)-centric, which makes it easy for just-in-time (JIT) compilers to generate code for CPUs where an ALU is the workhorse. According to an example embodiment, an ISA may be designed to be accelerator-centric instead of ALU-centric, which may enable efficient implementation of a hardware accelerator for a given function in the ISA. The ISA may be extensible and can evolve as workload requirements evolve over time. Such an ISA may be employed by a VM of a computer-based system, such as the computer-based system disclosed below with regard to FIG. 1A.

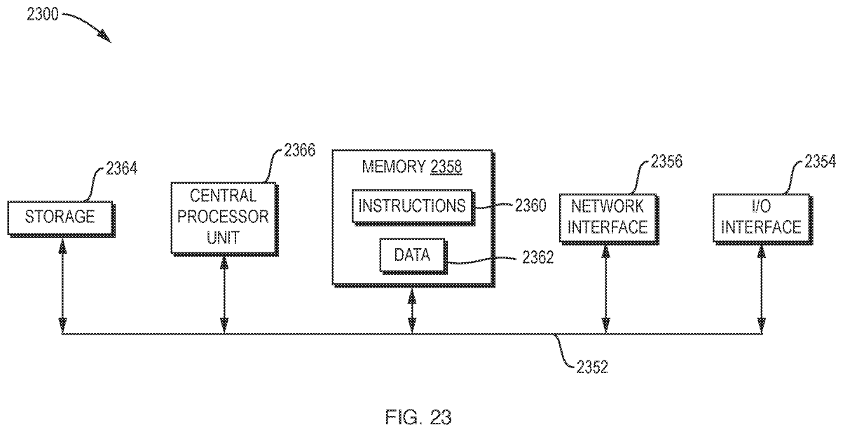

FIG. 1A is a block diagram of an example embodiment of a computer-based system 110, also referred to interchangeably herein as Insight. In the example embodiment of FIG. 1A, the system 110 comprises at least one VM (not shown), at least one processor (not shown), and memory (not shown) with computer code instructions (not shown) stored thereon, such as disclosed further below with regard to FIG. 23. Continuing with reference to FIG. 1A, the at least one processor and the memory, with the computer code instructions, may be configured to cause a VM 130 of the at least one VM to select an execution resource 140 from a set of execution resources (not shown) of the VM 130. The execution resource 140 may be for executing a VM instruction (not shown). The VM 130 may transform the VM instruction into machine code 119 for the execution resource selected 140. The VM 130 may execute the machine code 119 via the execution resource selected 140. The executing furthers execution by the VM 130 of a DFG 104 that includes at least one compute node (not shown). A compute node of the at least one compute node has a set of VM instructions (not shown) including the VM instruction. The DFG 104 corresponds to at least a portion of a computation workload (not shown) associated with a user data query 102. An output 108 of the execution of the DFG 104: (i) represents a result (not shown) of processing the at least a portion of the computation workload and (ii) contributes to a response 112 to the user data query 102. In the example embodiment, the user data query 102 is received from a user device 117 of a user 114 for non-limiting example. The user device 117 may be a personal computer (PC), laptop, table, smartphone, or any other user device for non-limiting examples.

In an example embodiment, the computer-based system 110 may further comprise at least one system resource set (not shown). Each system resource set of the at least one system resource set may be associated with a respective VM of the at least one VM. A system resource set (not shown) of the at least one system resource set may include at least one of: a PDU resource, a GPU resource, a memory resource, a network resource, another type of resource, or a combination thereof, for non-limiting examples.

In an example embodiment, the at least one processor and the memory, with the computer code instructions, may be further configured to cause the VM 130 to select the execution resource 140 based on at least one of: (i) a respective efficiency of executing the VM instruction at each execution resource of the set of execution resources and (ii) a respective availability of each execution resource of the set of execution resources.

According to another example embodiment, the VM instruction may be specified in an ISA. The ISA may be compatible with at least one type of computation workload. The at least one type of computation workload may include a type of the computation workload associated with the user data query 102. The at least one type of computation workload may include a SQL query plan, a data ingestion pipeline, an artificial intelligence (AI) or machine learning (ML) workload, a high-performance computing (HPC) program, another type of computation workload, or a combination thereof, for non-limiting examples.

Further, in yet another example embodiment, the at least one processor and the memory, with the computer code instructions, may be further configured to cause the VM 130 to select the execution resource 140 based on the execution resource 140 including an accelerator.

According to an example embodiment, the at least one processor and the memory, with the computer code instructions, may be further configured to cause the VM 130 to select the execution resource 140 based on the execution resource 140 including a PDU based accelerator, a GPU based accelerator, a tensor processing core (TPC) based accelerator, a tensor processing unit (TPU) based accelerator, a single instruction multiple data (SIMD) unit based accelerator, a CPU based accelerator, another type of accelerator, or a combination thereof, for non-limiting examples.

In another example embodiment, the compute node may be a first compute node. The at least one processor and the memory, with the computer code instructions, may be further configured to cause the VM 130 to process, via the first compute node, a first data block associated with the at least a portion of the computation workload. The at least one processor and the memory, with the computer code instructions, may be further configured to cause the VM 130 to, in parallel, perform at least one of: (i) processing, via a second compute node of the at least one compute node, a second data block associated with the at least a portion of the computation workload and (ii) transferring, via an edge of a set of edges (not shown) associated with the DFG 104, the second data block. The second data block may be associated with the at least a portion of the computation workload.

In an example embodiment, the at least one processor and the memory, with the computer code instructions, may be further configured to cause the VM 130 to control a flow of data blocks between at least two dataflow nodes (not shown) of the DFG 104. The at least two dataflow nodes may include the at least one compute node. The data blocks may be (i) associated with the at least a portion of the computation workload and (ii) derived from a data source 106 associated with the user data query 102. The data source 106 may be a data lake for non-limiting example.

According to another example embodiment, the at least one processor and the memory, with the computer code instructions, may be further configured to cause the VM 130 to perform validation of the DFG 104. Responsive to the validation being unsuccessful, the at least one processor and the memory, with the computer code instructions, may be further configured to cause the VM 130 to terminate execution of the DFG 104. Responsive to the validation being successful, the at least one processor and the memory, with the computer code instructions, may be further configured to cause the VM 130 to proceed with the execution of the DFG 104.

Further, in another example embodiment, the at least one processor and the memory, with the computer code instructions, may be further configured to cause the VM 130 to generate a set of edges associated with the DFG 104. Each edge of the set of edges may be configured to transfer data blocks between a corresponding pair of dataflow nodes (not shown) of the DFG 104. The dataflow nodes may include the at least one compute node. The at least one processor and the memory, with the computer code instructions, may be further configured to cause the VM 130 to configure an edge of the set of edges to transfer the data blocks using a first in first out (FIFO) queue. The at least one processor and the memory, with the computer code instructions, may be further configured to cause the VM 130 to configure, based on a user input, a size of the FIFO queue. The at least one processor and the memory, with the computer code instructions, may be further configured to cause the VM 130 to configure an edge of the set of edges to synchronize a first processing speed of a first compute node of the at least one compute node with a second processing speed of a second compute node of the at least one compute node.

According to an example embodiment, the at least one processor and the memory, with the computer code instructions, may be further configured to cause the VM 130 to execute the machine code 119 by performing at least one of: an input control function, a flow control function, a register control function, an output control function, a reduce function, a map function, a load function, and a generate function, for non-limiting examples.

In another example embodiment, the at least one processor and the memory, with the computer code instructions, may be further configured to cause the VM 130 to execute the VM instruction via a software-based execution unit (not shown), a hardware-based execution unit (not shown), or a combination thereof.

Further, according to yet another example embodiment, the DFG 104 may include at least one input node (not shown). The at least one processor and the memory, with the computer code instructions, may be further configured to cause the VM 130 to obtain, based on an input node of the at least one input node, at least one data block from a data source, e.g., 106, associated with the user data query 102. The at least one processor and the memory, with the computer code instructions, may be further configured to cause the VM 130 to obtain the at least one data block by implementing a read protocol corresponding to the data source 106.

In an example embodiment, the DFG 104 may include at least one output node (not shown). The at least one processor and the memory, with the computer code instructions, may be further configured to cause the VM 130 to store, based on an output node of the at least one output node, at least one data block to a datastore, e.g., the data source 106. The at least one processor and the memory, with the computer code instructions, may be further configured to cause the VM 130 to store the at least one data block by implementing a write protocol corresponding to the datastore, e.g., the data source 106.

According to another example embodiment, the at least one processor and the memory, with the computer code instructions, may be further configured to cause the VM 130 to spawn at least one task (not shown) corresponding to at least one of: (i) the at least one compute node, (ii) at least one input node (not shown) of the DFG 104, (iii) at least one output node (not shown) of the DFG 104, and (iv) at least one edge (not shown) associated with the DFG 104. A task of the at least one task spawned may include a thread (not shown) corresponding to the compute node. The at least one processor and the memory, with the computer code instructions, may be further configured to cause the VM 130 to execute the set of VM instructions via the thread. The at least one processor and the memory, with the computer code instructions, may be further configured to cause the VM 130 to monitor execution of a task of the at least one task spawned.

Further, in yet another example embodiment, the at least one processor and the memory, with the computer code instructions, may be further configured to cause the VM 130 to adapt the set of VM instructions based on at least one statistic (not shown) associated with the at least a portion of the computation workload. A statistic of the least one statistic may include a runtime statistical distribution of data values (not shown) in a data source, e.g., 106, associated with the user data query 102. The at least one processor and the memory, with the computer code instructions, may be further configured to cause the VM 130 to adapt the set of VM instructions responsive to identifying a mismatch between the runtime statistical distribution of the data values and an estimated statistical distribution of the data values. The at least one processor and the memory, with the computer code instructions, may be further configured to cause the VM 130 to adapt the set of VM instructions by performing at least one of: (i) reordering at least two VM instructions of the set of VM instructions, (ii) removing at least one VM instruction from the set of VM instructions, (iii) adding at least one VM instruction to the set of VM instructions, and (iv) modifying at least one VM instruction of the set of VM instructions for non-limiting examples.

According to an embodiment, the at least one processor and the memory, with the computer code instructions, may be further configured to cause the VM 130 to generate, based on the DFG 104, a plurality of dataflow subgraphs (not shown). The method may further comprise configuring at least two dataflow subgraphs of the plurality of dataflow subgraphs to, when executed via the VM 130, perform a data movement operation in parallel. The VM 130 may be a first VM. The data movement operation may include at least one of: (i) streaming data from a data source, e.g., 106, associated with the user data query 102 and (ii) transferring data to or from a second VM (not shown). The computer-based system 110 may be employed as part of a data analytics cluster, such as disclosed below with regard to FIG. 1B.

FIG. 1B is a block diagram of an example embodiment of a data analytics compute cluster 100. With regard to FIG. 1A and FIG. 1B, the cluster 100 includes the computer-based system 110, e.g., Insight, a distributed compiler 120, the VM 130, and a PDU execution unit 140. Optionally, the cluster 100 may also include a query back-end 150. According to an example embodiment, the cluster 100 may also include other components/modules (not shown), such as a shared state service, performance monitor service, etc., for non-limiting examples. According to an example embodiment, the compiler 120 may provide features such as DFG conversion, execution orchestration, etc., for non-limiting examples. The VM 130 may provide features, such as DFG execution, data path implementation, etc., for non-limiting examples. The optional back-end 150 may provide features, such as query planning, optimization, etc., for non-limiting examples. According to an example embodiment, the system 110, compiler 120, VM 130, optional back-end 150, shared state service, and performance monitor service may be implemented variously as services or stateful applications using a container orchestration system, such as a Kubernetes® (K8s®) system, or any other suitable container system known to those of skill in the art for non-limiting examples.

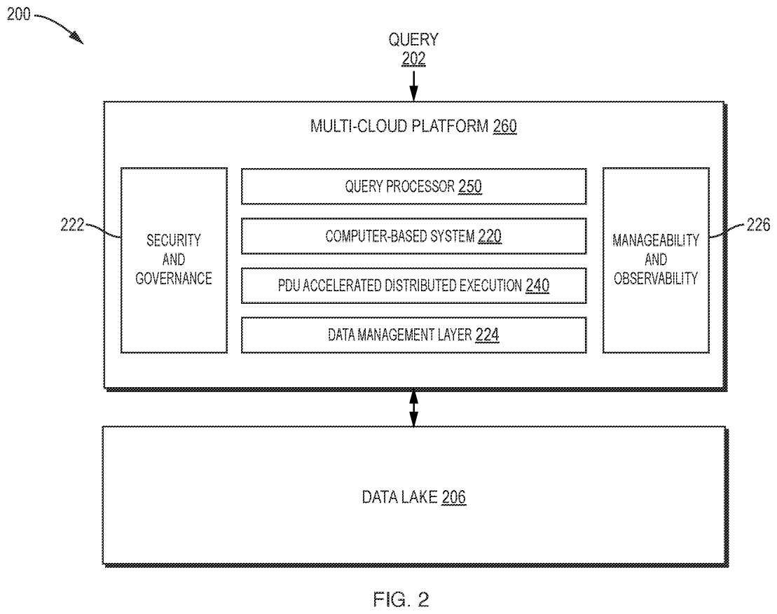

FIG. 2 is a block diagram of an example embodiment of a data analytics system 200. The system 200 includes a data lake 206, for non-limiting example, that may be configured to store structured and/or unstructured data. Alternatively, a plurality of data lakes (not shown), or a combination of data lakes, data warehouses and/or other data stores, may be implemented in place of the data lake 206. A multi-cloud analytics platform 260 may be configured to receive a data query, e.g., the query 202 which may be the user data query 102 of FIG. 1A, disclosed above, to analyze data of the data lake 206 in accordance with the query 202, and may be further configured to provide a corresponding result to a user, such as the response 112 provided to the user 114 of FIG. 1A. Continuing with reference to FIG. 2, the platform 260 may be implemented via a plurality of cloud networks (not shown) that may each include at least one server (not shown), as described in further detail below. Functional elements of the platform 260 are shown in FIG. 2, including a query processor 250, the computer-based system 210, a PDU block 240, a data management layer 224, a security manager 222, and a management controller 226 for non-limiting examples.

The query processor 250 may be configured to receive the query 202 from a user. The query 202 may be written in a data analytics language, such as a SQL or Python language, for non-limiting examples, and represents the user's intent for analysis of the data stored at the data lake 206. The query processor 250 may receive and process the query 202 to generate a corresponding DFG, which defines an analytics operation as a tree of nodes, each node representing a distinct action. The computer-based system 210 may be the computer-based system 110 of FIGS. 1A and 1B, disclosed above, and transforms the DFG into machine-readable instructions for execution by a VM operated at the PDU block 240. The computer-based system 210 may also be referred to herein as Insight. Continuing with reference to FIG. 2, the data management layer 224 interfaces with the data lake 206 to access data requested by the PDU block 240. The security manager 222 provides secure access to the platform 260 and may control authentication, authorization, and confidentiality components, among other examples, of the platform 260. Lastly, the management controller 226 may enable users to view and manage operations of the platform 260, and may manage components of the platform 260, such as monitoring, relocation of components in response to a failure, scaling on up and down, and observing the usage and performance of components.

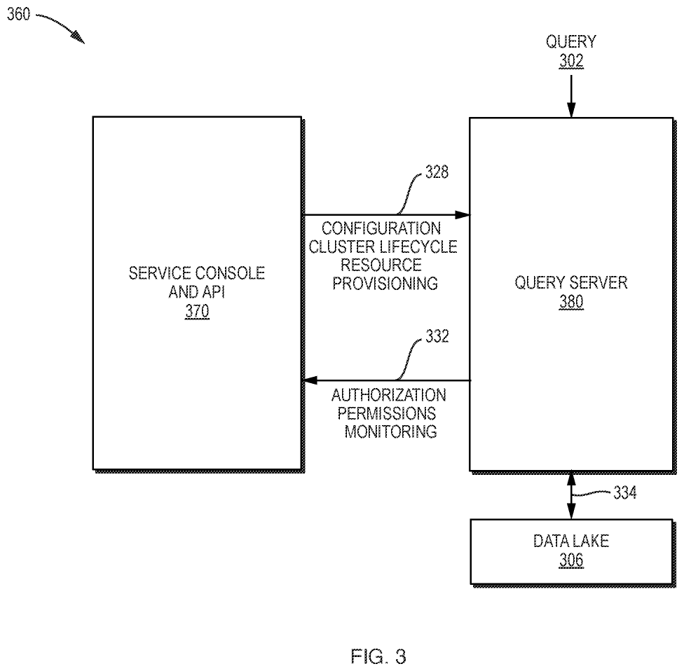

The analytics platform 260 can provide several advantages over conventional data analytics solutions. For example, the platform 260 can be scaled easily to service data lakes of any size while meeting demands for reliable data analytics, providing a fully managed analytics service on decentralized data. Further, because the platform 260 can process data regardless of its location and format, it can be adapted to any data store, such as the data lake 206, without changing or relocating the data. The platform 260 may be employed as a multi-cloud analytics platform, disclosed below with regard to FIG. 3.

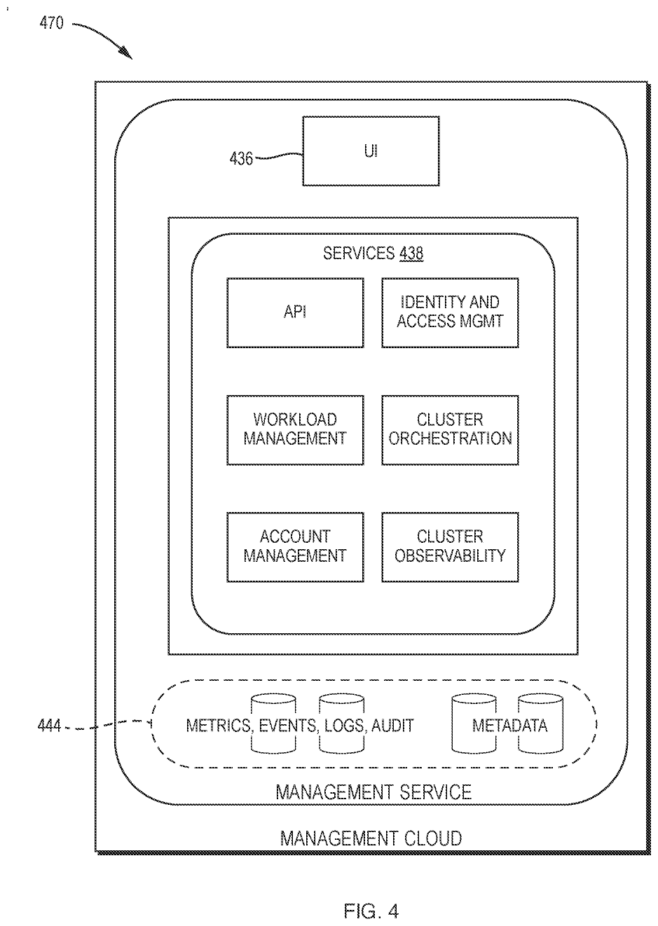

FIG. 3 is a block diagram of an example embodiment of a multi-cloud analytics platform 360. In the example embodiment of FIG. 3, the analytics platform 360 is shown as two networked servers, a service console server 370, and a query server 380 for non-limiting example. The servers 370, 380 may each include one or more physical servers configured as a cloud service. The service console server 370 may provide a user interface (not shown) to a managing user through a connected device (not shown), enabling the managing user to monitor the performance and configuration of the query server 380. The query server 380 may communicate with a client user (such as an owner of a data lake, e.g., data lake 306, data lake 206 of FIG. 2, or data source 106 of FIG. 1A) to receive a query, e.g., query 302, user data query 202 (FIG. 2), or user data query 102 (FIG. 1A), to access the data lake 306 to perform an analytics operation in accordance with the query 302, and return a corresponding result to the user, such as disclosed above with regard to FIGS. 1A and 1B. Continuing with reference to FIG. 3, the service console server 370 may transmit management and configuration commands 328 to manage the query server 380, while the query server 380 may provide monitoring communications 332 to the service console server 370. An example embodiment of such a service console server is disclosed below with regard to FIG. 4.

FIG. 4 is a block diagram of an example embodiment of a service console server 470, with attention to functional blocks that may be operated by the service console server 470. A user interface (UI) 436 can be accessed by a managing user via a computing device (not shown) connected via the Internet or another network, and provides the managing user with access to a plurality of services 438:
a) Application Programming Interface (API): Provides the necessary functionality to drive the UI 436.
b) Identity and Access Management: Provides authentication services, including verifying the authenticity of the platform user and authorization, and controlling access to various components of the platform to various platform users.
c) Workload Management: Manages the control plane workloads, such as creating a cluster and destroying a cluster.
d) Cluster Orchestration: Controls operations to create, destroy, start, stop, and relocate the clusters.
e) Account Management: Manages the customer account and users within the customer account.
f) Cluster Observability: Monitors the cluster for usage and failures so that it can be relocated to other physical machines if the failures rate crosses a threshold.

The service console server 470 may also include a data store 444 configured to store a range of data associated with a platform, e.g., platform 260 (FIG. 2), such as performance metrics, operational events (e.g., alerts), logs indicating queries and responses, and operational metadata, for non-limiting examples.

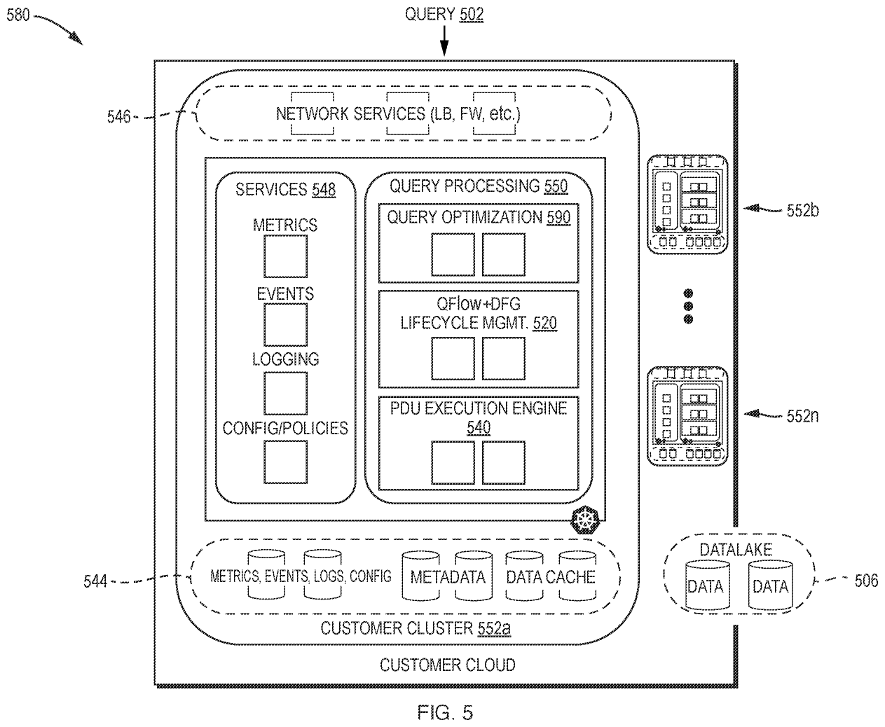

FIG. 5 is a block diagram of an example embodiment of a query server 580, with attention to functional blocks that may be operated by the server 580. As a cloud service, the query server 580 may include a plurality of server clusters 552a-n, of which server 552a is shown in detail. Each of the server clusters 552a-n may be communicatively coupled to a data lake, e.g., the data lake 506, 306 (FIG. 3), 206 (FIG. 2), or 106 (FIG. 1A), to allow independent access to data stored thereon. In response to a query, e.g., the query 502, 302 (FIG. 3), 202 (FIG. 2), or 102 (FIG. 1A), the server clusters 552a-n may coordinate to determine an efficient distribution of tasks to process such query, execute analytics tasks, and generate a corresponding response.

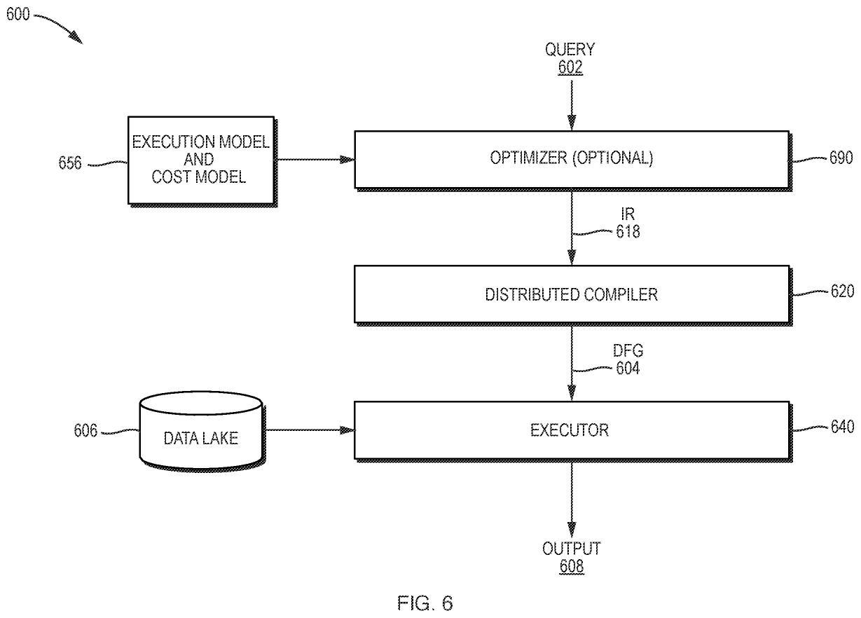

The server cluster 552a is depicted as a plurality of functional blocks that may be performed by a combination of hardware and software as described in further detail below. Network services 546 may be configured to interface with a user device (not shown) across a network to receive a query, return a response, and communicate with a service console server, e.g., the server 370 (FIG. 3) or 470 (FIG. 4). The query services 550 may include a query optimization block 590, a computer-based system 510, and a PDU executor 540. The computer-based system 510 may be the computer-based system 110 or 210, disclosed above with regard to FIGS. 1A-B and 2, respectively. As described further below with reference to FIG. 6, the query services 550 of FIG. 5 may operate to generate an intermediate representation (IR) of a query (optionally including one or more optimizations), produce DFG(s) defining execution of the generated IR, and execute the query.

Continuing with reference to FIG. 5, the management services block 548 may monitor operation of the server cluster 552a, recording performance metrics and events and maintaining a log of the same. The management services block 548 may also govern operation of the query services 550 based on a set of configurations and policies determined by a user. Further, the management services block 548 may communicate with the service console server, e.g., 370 (FIG. 3) or 470 (FIG. 4), to convey performance metrics and events and to update policies as communicated by the server, e.g., 370 or 470. Lastly, a data store 544 may be configured to store the data controlled by the management services block 548, including performance metrics, operational events, logs indicating queries and responses, and operational metadata, for non-limiting examples. The data store 544 may also include a data cache configured to store a selection of data retrieved from the data lake, e.g., 506, 306 (FIG. 3), 206 (FIG. 2), or 106 (FIG. 1A), for use by the query services 550 for executing a query. An example embodiment of a data analysis process that may be performed by the server 580 is disclosed below with regard to FIG. 6.

FIG. 6 is a flow diagram of an example embodiment of a data analysis process 600 that may be performed by a query server, e.g., server 380 (FIG. 3) or 580 (FIG. 5). In the example embodiment of FIG. 6, an optional query optimizer 690 may receive a query, e.g., query 602, 502 (FIG. 5), 302 (FIG. 3), 202 (FIG. 2), or 102 (FIG. 1A), for processing, as well as execution model(s) 656 for reference in optimizing the query. For example, an execution model 656 may specify relevant information on the hardware and software configuration of the PDU executor 158, enabling the query optimizer 156 to adapt an IR to the capabilities and limitations of a PDU executor, e.g., the executor 640, 540 (FIG. 5), 240 (FIG. 2), or 140 (FIG. 1A). Further, a cost model 656 may specify user-defined limitations regarding resources to dedicate to processing a query over a given timeframe. The optional query optimizer 690 may utilize such a cost model 656 to prioritize a query relative to other queries, define a maximum or minimum number of PDUs to be assigned for the query, and/or lengthen or shorten a timeframe in which to process the query. According to an example embodiment, when invoked, the optional query optimizer 690 may apply optimizations such as customized execution operators and/or and rewrite rules, among other examples. According to an example embodiment, the optional query optimizer 690 may also, or alternatively, apply heuristic-based optimizations and/or any suitable known type of optimization, such as a Volcano optimization, for non-limiting example.

The computer-based system 610 may receive an IR 618 (optionally optimized by the query optimizer 690) and generate corresponding DFG(s) 604 that define how the query is to be performed by the PDU executor 640. For example, the DFG(s) 604 may define the particular PDUs to be utilized in executing the query, the specific processing functions to be performed by those PDUs, a sequence of functions connecting inputs and outputs of each function, and compilation of the results to be returned to the user. Finally, the PDU executor 640 may access a data lake, e.g., data lake 606, 506 (FIG. 5), 306 (FIG. 3), 206 (FIG. 2), or 106 (FIG. 1A), perform the query on the accessed data as defined by the DFG(s) 604, and return a corresponding output, e.g., the output 608 or 108 (FIG. 1A). In an embodiment, data lake 606 may be, e.g., Amazon S3®, Microsoft® Azure, PostgreSQL®, or another suitable data lake known to those of skill in the art.

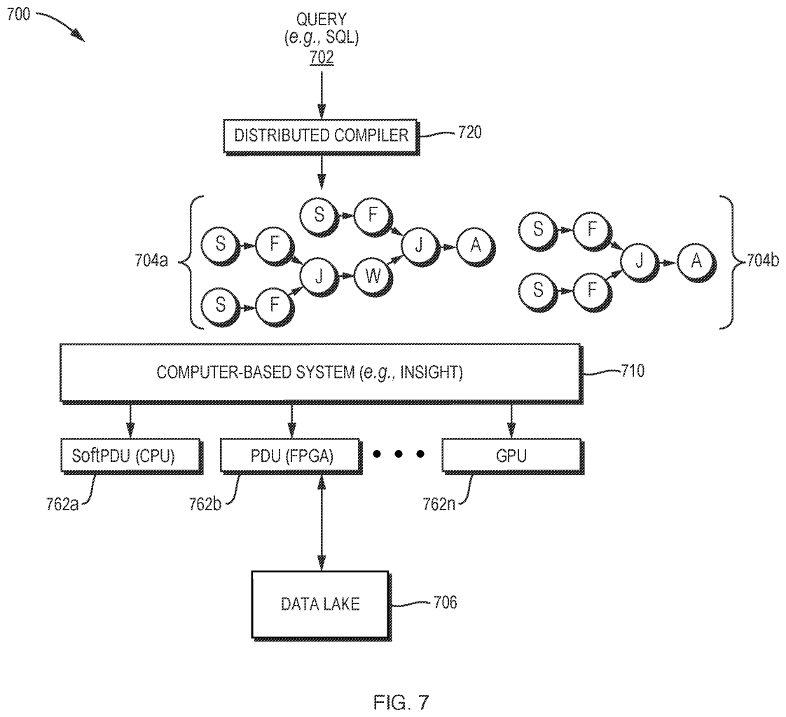

FIG. 7 is a block diagram of an example embodiment of a disaggregated data analytics stack 700 with domain-specific computing. The stack 700 includes a distributed compiler, e.g., the distributed compiler 720, 620 (FIG. 6), 520 (FIG. 5), 220 (FIG. 2), or 120 (FIG. 1B). With reference to FIG. 7, the distributed compiler 720 may receive a user data query, e.g., the query 702, 602 (FIG. 6), 502 (FIG. 5), 302 (FIG. 3), 202 (FIG. 2), or 102 (FIG. 1A). The user data query 702 may be received from a front-end framework (not shown) such as an Apache Spark™, Python, Presto, or SQL framework, or any other suitable framework known to those of skill in the art for non-limiting examples.

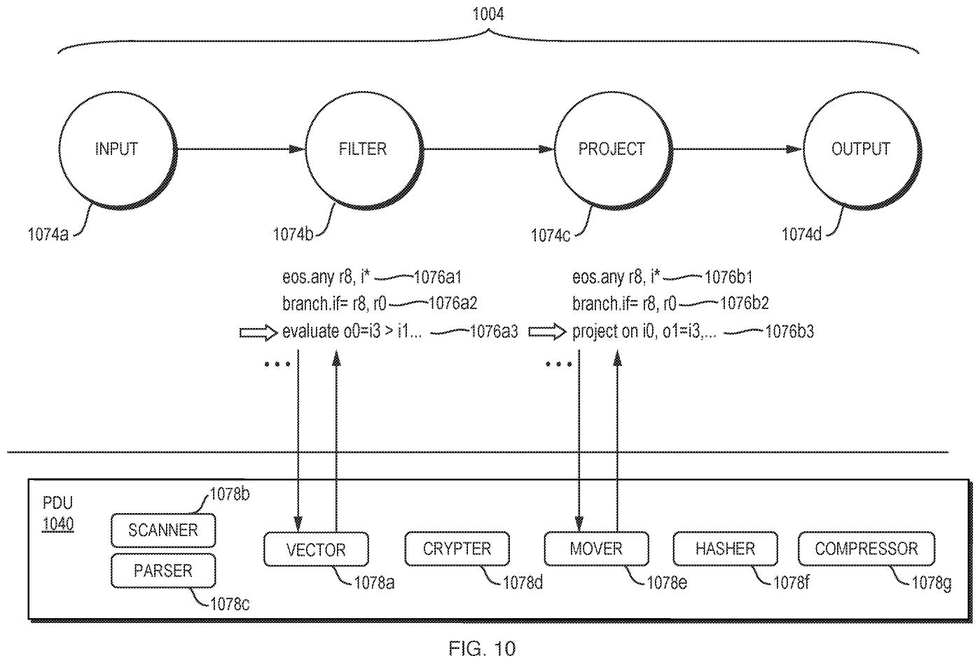

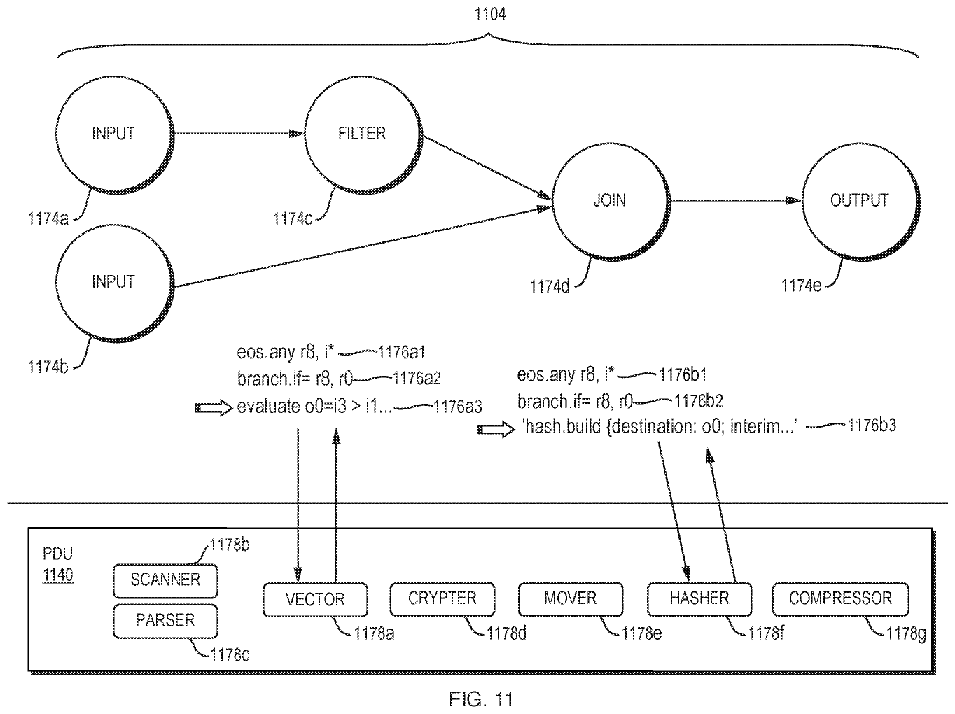

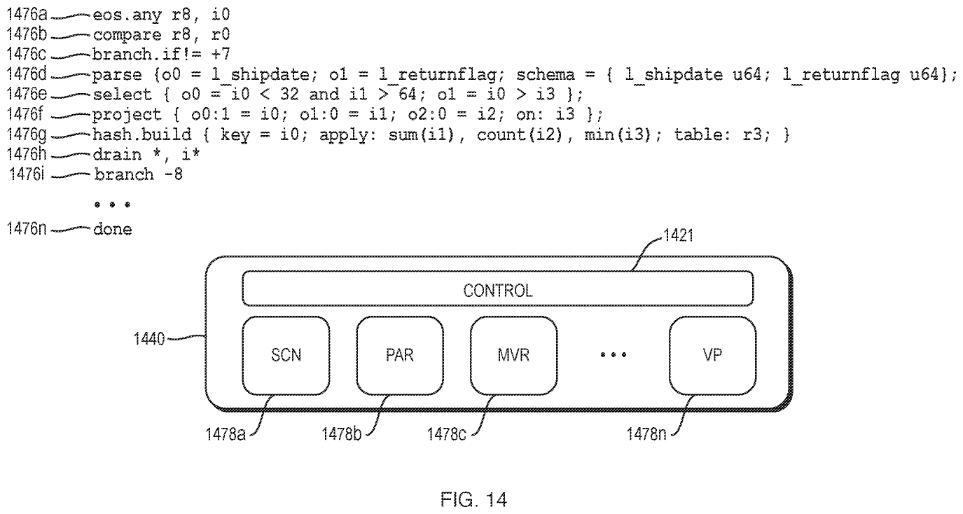

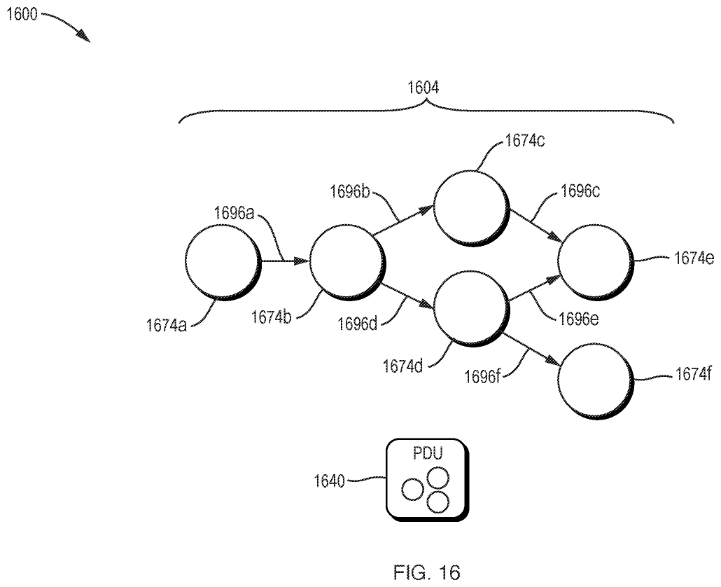

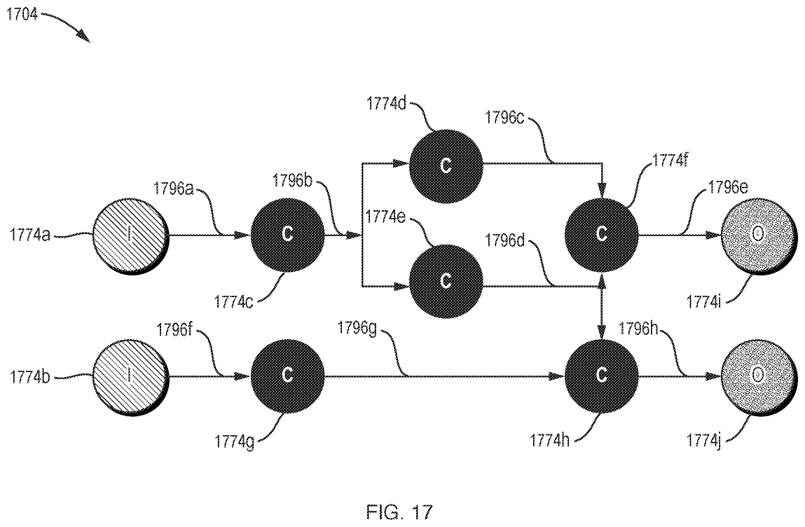

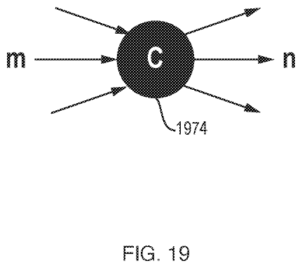

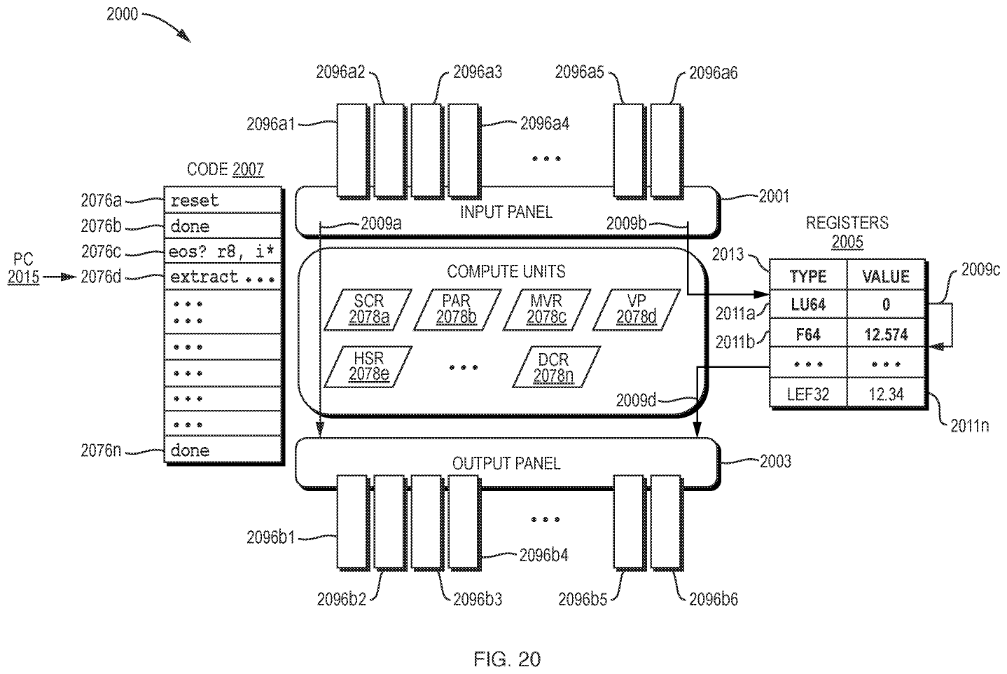

Continuing with reference to FIG. 7, the distributed compiler 720 may compile the user data query 702 into DFGs, e.g., DFGs 704a-b, 604 (FIG. 6), or 104 (FIG. 1A). The DFGs 704a-b may include dataflow nodes, e.g., dataflow nodes 1074a-d (FIG. 10), 1174a-e (FIG. 11), 1674a-f (FIG. 16), 1774a-j (FIG. 17), or 1974 (FIG. 19) disclosed further below. The dataflow nodes may include VM instruction(s), e.g., VM instruction(s) 1076a1-3 and/or 1076b1-3 (FIG. 10), 1176a1-3 and/or 1176b1-3 (FIG. 11), 1476a-n (FIG. 14), or 2076a-n (FIG. 20), in a domain-specific ISA for data computing, as disclosed further below.

Continuing with reference to FIG. 7, the stack 700 may also include a computer-based system 710 with resource(s), e.g., SoftPDU 762a (i.e., a software-based PDU executing on a CPU), a PDU 762b (i.e., a hardware-based PDU implemented via a FPGA (field-programmable gate array)), and a GPU 762n. According to an example embodiment, the system 710 may select an execution resource from a set of execution resources, e.g., 762a-n, of a VM, e.g., VM 130 (FIG. 1A). The execution resource may be for executing a VM instruction, e.g., 1076a1-3 (FIG. 10), 1076b1-3 (FIG. 10), 1176a1-3 (FIG. 11), 1176b1-3 (FIG. 11), 1476a-n (FIG. 14), or 2076a-n (FIG. 20). The system 710 may transform the VM instruction into machine code for the execution resource selected. The system 710 may execute the machine code via the execution resource selected. The executing furthers execution by the VM of a dataflow graph, e.g., 704a or 704b, that includes at least one compute node, e.g., compute node 1674b-d (FIG. 16), 1774c-h (FIG. 17), or 1974 (FIG. 19). A compute node of the at least one compute node has a set of VM instructions, e.g., 1076a1-3 (FIG. 10), 1076b1-3 (FIG. 10), 1176a1-3 (FIG. 11), 1176b1-3 (FIG. 11), 1476a-n (FIG. 14), or 2076a-n (FIG. 20), including the VM instruction. Continuing with reference to FIG. 7, the dataflow graph, e.g., 704a or 704b, corresponds to at least a portion of a computation workload associated with the user data query 702. An output of the execution of the dataflow graph, e.g., 704a or 704b: (i) represents a result of processing the at least a portion of the computation workload and (ii) contributes to a response, e.g., response 112 (FIG. 1A), to the user data query 702.

In an example embodiment, the selecting may be based on at least one of: (i) a respective efficiency of executing the VM instruction, e.g., 1076a1-3 (FIG. 10), 1076b1-3 (FIG. 10), 1176a1-3 (FIG. 11), 1176b1-3 (FIG. 11), 1476a-n (FIG. 14), or 2076a-n (FIG. 20), at each execution resource of the set of execution resources, e.g., 762a-n, and (ii) a respective availability of each execution resource of the set of execution resources, e.g., 762a-n.

According to another example embodiment, the VM instruction, e.g., 1076a1-3 (FIG. 10), 1076b1-3 (FIG. 10), 1176a1-3 (FIG. 11), 1176b1-3 (FIG. 11), 1476a-n (FIG. 14), or 2076a-n (FIG. 20), may be specified in the ISA. The ISA may be compatible with at least one type of computation workload. The at least one type of computation workload may include a type of the computation workload associated with the user data query 702. The at least one type of computation workload may include a SQL query plan, a data ingestion pipeline, an artificial intelligence (AI) or machine learning (ML) workload, a high-performance computing (HPC) program, another type of computation workload, or a combination thereof, for non-limiting examples.

Further, in another example embodiment, selecting the execution resource may be based on the execution resource including an accelerator.

According to an example embodiment, selecting the execution resource may be based on the execution resource including a PDU based accelerator, a GPU based accelerator, a TPC based accelerator, a TPU based accelerator, a SIMD unit based accelerator, a CPU based accelerator, another type of accelerator, or a combination thereof, for non-limiting examples.

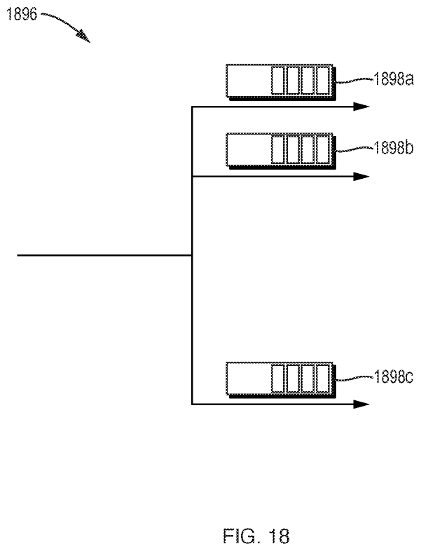

In another example embodiment, the compute node, e.g., 1674b-d (FIG. 16), 1774c-h (FIG. 17), or 1974 (FIG. 19), may be a first compute node. The system 710 may process, via the first compute node, a first data block associated with the at least a portion of the computation workload. The processing may be performed in parallel with at least one of: (i) processing, via a second compute node of the at least one compute node, e.g., 1674b-d (FIG. 16), 1774c-h (FIG. 17), or 1974 (FIG. 19), a second data block associated with the at least a portion of the computation workload and (ii) transferring, via an edge of a set of edges, e.g., edge(s) 1696a-f (FIG. 16), 1796a-h (FIG. 17), 1896 (FIG. 18), or 2096a1-6 and/or 2096b1-6 (FIG. 20), the second data block. The second data block may be associated with the at least a portion of the computation workload.

In another example embodiment, consider a non-limiting example of a DFG including compute nodes N1→N2→N3 for processing data blocks B1, B2, and B3, respectively. Each of the nodes N1, N2, and N3 may process blocks in parallel with the other nodes. The blocks B1, B2, and B3 may be processed respectively in chronological or time order. For instance, the node N1 may be a first compute node and the block B2 may be an initial data block associated with at least a portion of a computation workload, while the node N2 may be a second compute node and the block B1 may be a subsequent data block associated with the at least a portion of the computation workload. The initial data block B2 may be processed via the first compute node N1, in parallel with the subsequent data block B1 being processed via the second compute node N2. Moreover, the first compute node N1 may have already processed the subsequent data block B1 prior to it being processed by the second compute node N2. As should be appreciated from the foregoing example, any two (or three, etc.) data blocks, e.g., B1 and B2, may be processed in parallel (e.g., via nodes N2 and N1, respectively); however, each individual data block, e.g., B1 and B2, may be processed in time order (e.g., by node N1 followed by node N2, and so on). Continuing with reference to FIG. 7, according to an example embodiment, the stack 700 may further include a data lake, e.g., the data lake 706, 606 (FIG. 6), 306 (FIG. 3), 206 (FIG. 2), or 106 (FIG. 1A). The data lake 706 may be, e.g., a Microsoft Azure, Amazon S3, or Google Cloud Storage™ data lake, or another suitable data lake known to those of skill in the art for non-limiting examples.

In an example embodiment, the system 710 may control a flow of data blocks between at least two dataflow nodes, e.g., 1074a-d (FIG. 10), 1174a-e (FIG. 11), 1674a-f (FIG. 16), 1774a-j (FIG. 17), or 1974 (FIG. 19), of the dataflow graph, e.g., 704a or 704b. The at least two dataflow nodes may include the at least one compute node, e.g., 1674b-d (FIG. 16), 1774c-h (FIG. 17), or 1974 (FIG. 19). The data blocks may be (i) associated with the at least a portion of the computation workload and (ii) derived from a data source, e.g., the data lake 706, associated with the user data query 702.

According to another example embodiment, the system 710 may perform validation of the dataflow graph, e.g., 704a or 704b. Responsive to the validation being unsuccessful, the system 710 may terminate execution of the dataflow graph, e.g., 704a or 704b. Responsive to the validation being successful, the system 710 may proceed with the execution of the dataflow graph, e.g., 704a or 704b.

Further, according to another example embodiment, the system 710 may generate a set of edges, e.g., 1696a-f (FIG. 16), 1796a-h (FIG. 17), 1896 (FIG. 18), or 2096a1-6 and/or 2096b1-6 (FIG. 20), associated with the dataflow graph, e.g., 704a or 704b. Each edge of the set of edges, e.g., 1696a-f (FIG. 16), 1796a-h (FIG. 17), 1896 (FIG. 18), or 2096a1-6 and/or 2096b1-6 (FIG. 20), may be configured to transfer data blocks between a corresponding pair of dataflow nodes, e.g., 1074a-d (FIG. 10), 1174a-e (FIG. 11), 1674a-f (FIG. 16), 1774a-j (FIG. 17), or 1974 (FIG. 19), of the dataflow graph, e.g., 704a or 704b. The dataflow nodes, e.g., 1074a-d (FIG. 10), 1174a-e (FIG. 11), 1674a-f (FIG. 16), 1774a-j (FIG. 17), or 1974 (FIG. 19), may include the at least one compute node, e.g., 1674b-d (FIG. 16), 1774c-h (FIG. 17), or 1974 (FIG. 19). The generating may include configuring an edge of the set of edges, e.g., 1696a-f (FIG. 16), 1796a-h (FIG. 17), 1896 (FIG. 18), or 2096a1-6 and/or 2096b1-6 (FIG. 20), to transfer the data blocks using a FIFO queue. The system 710 may configure, based on a user input, a size of the FIFO queue. The generating may include configuring an edge of the set of edges, e.g., 1696a-f (FIG. 16), 1796a-h (FIG. 17), 1896 (FIG. 18), or 2096a1-6 and/or 2096b1-6 (FIG. 20), to synchronize a first processing speed of a first compute node of the at least one compute node, e.g., 1674b-d (FIG. 16), 1774c-h (FIG. 17), or 1974 (FIG. 19), with a second processing speed of a second compute node of the at least one compute node, e.g., 1674b-d (FIG. 16), 1774c-h (FIG. 17), or 1974 (FIG. 19).

According to an example embodiment, the executing may include performing at least one of: an input control function, a flow control function, a register control function, an output control function, a reduce function, a map function, a load function, and a generate function, for non-limiting examples.

In another example embodiment, the executing may include executing the VM instruction, e.g., 1076a1-3 (FIG. 10), 1076b1-3 (FIG. 10), 1176a1-3 (FIG. 11), 1176b1-3 (FIG. 11), 1476a-n (FIG. 14), or 2076a-n (FIG. 20), via a software-based execution unit, e.g., 762a, a hardware-based execution unit, e.g., 762b or 762n, or a combination thereof.

Further with reference to FIG. 7, according to another example embodiment, the dataflow graph, e.g., 704a or 704b, may include at least one input node, e.g., input node 1074a (FIG. 10), 1174a-b (FIG. 11), 1674a (FIG. 16), or 1774a-b (FIG. 17). The system 710 may obtain, based on an input node of the at least one input node, e.g., 1074a (FIG. 10), 1174a-b (FIG. 11), 1674a (FIG. 16), or 1774a-b (FIG. 17), at least one data block from a data source, e.g., 706, associated with the user data query 702. The obtaining may include implementing a read protocol corresponding to the data source.

In an example embodiment, the dataflow graph, e.g., 704a or 704b, may include at least one output node, e.g., output node 1074d (FIG. 10), 1174e (FIG. 11), 1674e-f (FIG. 16), or 1774i-j (FIG. 17). The system 710 may store, based on an output node of the at least one output node, e.g., 1074d, 1174e, 1674e-f, or 1774i-j of FIGS. 10, 11, 16, and 17, respectively, at least one data block to a datastore, e.g., 706 of FIG. 7. The storing may include implementing a write protocol corresponding to the datastore.

According to another example embodiment and with reference to FIGS. 7, 10, 11, 14, and 16-20, the system 710 may spawn at least one task corresponding to at least one of: (i) the at least one compute node, e.g., 1674b-d, 1774c-h, or 1974, (ii) at least one input node, e.g., 1074a, 1174a-b, 1674a, or 1774a-b, of the dataflow graph, e.g., 704a or 704b, (iii) at least one output node, e.g., 1074d, 1174e, 1674e-f, or 1774i-j, of the dataflow graph, e.g., 704a or 704b, and (iv) at least one edge, e.g., 1696a-f, 1796a-h, 1896, 2096a1-6, or 2096b1-6, associated with the dataflow graph, e.g., 704a or 704b. A task of the at least one task spawned may include a thread corresponding to the compute node, e.g., 1674b-d, 1774c-h, or 1974. The system 710 may execute the set of VM instructions, e.g., 1076a1-3, 1076b1-3, 1176a1-3, 1176b1-3, 1476a-n, or 2076a-n, via the thread. The system 710 may monitor execution of a task of the at least one task spawned.

Further, according to another example embodiment, the system 710 may adapt the set of VM instructions, e.g., 1076a1-3, 1076b1-3, 1176a1-3, 1176b1-3, 1476a-n, or 2076a-n, based on at least one statistic associated with the at least a portion of the computation workload. A statistic of the least one statistic may include a runtime statistical distribution of data values in a data source, e.g., 706, associated with the user data query 702. The adapting may be responsive to identifying a mismatch between the runtime statistical distribution of the data values and an estimated statistical distribution of the data values. The adapting may include at least one of: (i) reordering at least two VM instructions of the set of VM instructions, e.g., 1076a1-3, 1076b1-3, 1176a1-3, 1176b1-3, 1476a-n, or 2076a-n, (ii) removing at least one VM instruction from the set of VM instructions, e.g., 1076a1-3, 1076b1-3, 1176a1-3, 1176b1-3, 1476a-n, or 2076a-n, (iii) adding at least one VM instruction to the set of VM instructions, e.g., 1076a1-3, 1076b1-3, 1176a1-3, 1176b1-3, 1476a-n, or 2076a-n, and (iv) modifying at least one VM instruction of the set of VM instructions, e.g., 1076a1-3, 1076b1-3, 1176a1-3, 1176b1-3, 1476a-n, or 2076a-n.

According to an example embodiment, the system 710 may generate, based on the dataflow graph, e.g., 704a or 704b, a plurality of dataflow subgraphs. The method may further comprise configuring at least two dataflow subgraphs of the plurality of dataflow subgraphs to, when executed via the VM, e.g., 130, perform a data movement operation, in parallel. The VM, e.g., 130, may be a first VM. The data movement operation may include at least one of: (i) streaming data from a data source, e.g., 706, associated with the user data query 702 and (ii) transferring data to or from a second VM.

Continuing with reference to FIG. 7, according to an example embodiment, the disaggregated data analytics stack 700 may provide one or more benefits, such as improved efficiency and agility, among other examples for non-limiting examples. The disaggregated data analytics stack 700 may further supply an end-to-end framework to express general-purpose computations on Big Data (e.g., datasets that are too large and/or complex to be analyzed using conventional approaches).

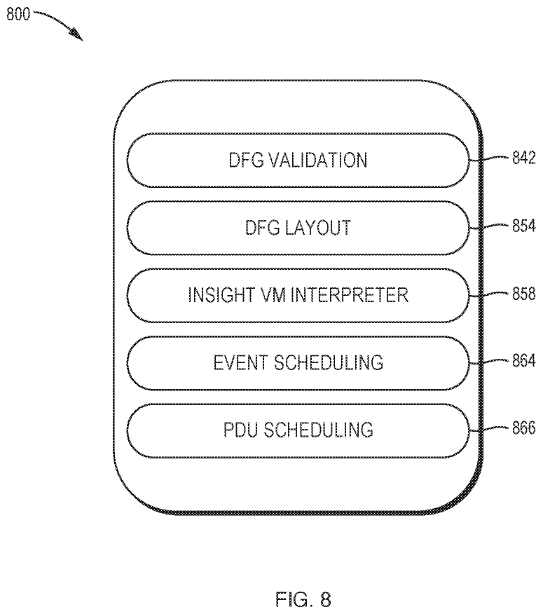

FIG. 8 is a block diagram of an example embodiment of a third phase 800 of a data analytics pipeline. According to an example embodiment, the third phase 800 may be implemented by a computer-based system, e.g., system 110 (FIG. 1A) or 710 (FIG. 7). In an example embodiment, the system may receive a DFG, e.g., DFG 104 (FIG. 1A), 604 (FIG. 6), or 704a-b (FIG. 7). According to another example embodiment, after the optional validation 842 of the received DFG, the second phase 800 may include laying out 854 the DFG in memory, creating FIFO queue(s), and/or connecting edges between nodes of the DFG. In turn, according to another example embodiment, the second phase 800 may include launching a VM interpreter 858 for each compute node of the DFG. Further, in an example embodiment, as part of the second phase 800, input nodes of the DFG may start fetching data and feeding it into the DFG and output nodes of the DFG may start pulling data from the DFG and pushing it to external sinks. According to another example embodiment, compute nodes of the DFG may start interpreting their code and using a PDU to execute data blocks fed into them. In yet another example embodiment, second phase 800 may also include event scheduling 864 and PDU scheduling 866. According to an embodiment, as part of the event scheduling 864, a task (e.g., a process/subprocess or thread) may be spawned for each edge and node in the DFG. In another example embodiment, nodes in the DFG may be assigned various task priorities for non-limiting example. For instance, according to yet another example embodiment, I/O tasks may need a higher priority than other tasks, e.g., because network bandwidth may be a scarce resource and keeping the network bandwidth utilized or busy may be a high priority, for non-limiting example. In an example embodiment, the event scheduling module 864 may manage such tasks and/or assign VM execution resources (e.g., CPU resources) to tasks depending on the tasks' priorities and/or activities, for non-limiting examples.

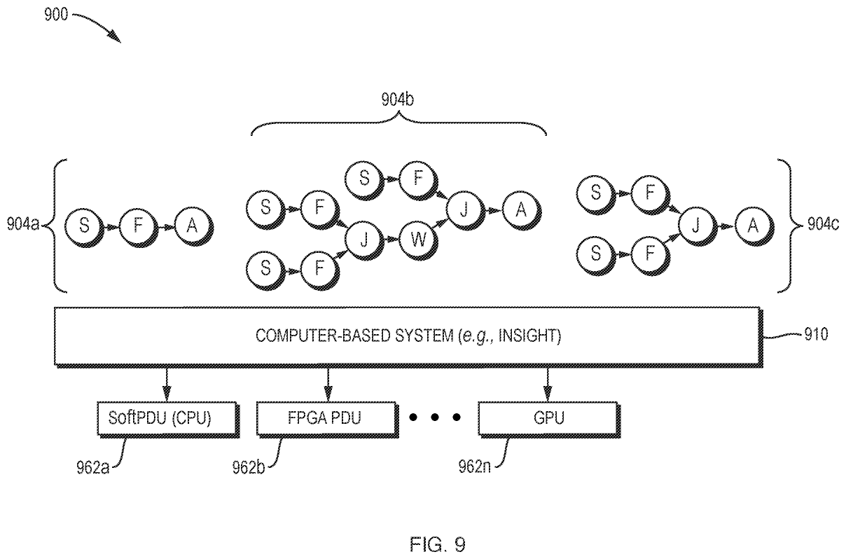

FIG. 9 is a flow diagram of an example embodiment of a process 900 for a hardware-agnostic domain-specific VM. The process 900 may be performed by a computer-based system according to example embodiments, e.g., computer-based system 910 or 110 (FIG. 1A). With reference to FIG. 9, in an example embodiment, the computer-based system 910 may employ a runtime interpreter, e.g., VM interpreter 858 (FIG. 8), to execute computation(s) expressed as DFG(s) 904a-c generated by a distributed compiler, e.g., distributed compiler 120 (FIG. 1B), 220 (FIG. 2), 520 (FIG. 5), 620 (FIG. 6), or 720 (FIG. 7). Moreover, the process 900 is a non-limiting example of extensive parallelism and streaming of data. Further, in another example embodiment, the process 900 may leverage existing cloud infrastructure for execution unit(s), e.g., SoftPDU 962a. FPGA PDU 962b, and/or GPU 962n, etc.; additional non-limiting examples of PDU execution units are provided hereinbelow in relation to FIG. 10. According to ab example embodiment, the computer-based system 910 may optionally execute one or more adaptive query optimization(s). In yet another example embodiment, the computer-based system 910 may schedule specific computation(s) of the DFG(s) 904a-c to the appropriate computing element, e.g., the SoftPDU 962a. FPGA PDU 962b, and/or GPU 962n.

FIG. 10 is a block diagram of an example embodiment of mapping machine code of a DFG 1004 to a PDU 1040. In the example embodiment of FIG. 10, the DFG 1004 includes dataflow nodes 1074a-d. In turn, the dataflow node 1074b (e.g., a filtering node) of the DFG 1004 may include the machine code instructions 1076a1-3; likewise, the dataflow node 1074c (e.g., a projection node) of the DFG 1004 may include the machine code instructions 1076b1-3 for non-limiting examples. According to an example embodiment, the machine code instruction 1076a3 (e.g., an evaluate instruction) of the dataflow node 1074b may be mapped to a vector unit 1078a of the PDU 1040, which may also include a scanner unit 1078b, parser unit 1078c, crypter unit 1078d, mover unit 1078e, hasher unit 1078f, and compressor unit 1078g, for non-limiting examples. Similarly, in another example embodiment, the machine code instruction 1076b3 (e.g., a projection instruction) of the dataflow node 1074c may be mapped to the mover unit 1078e of the PDU 1040.

FIG. 11 is a block diagram of another example embodiment of mapping machine code of a DFG 1104 to a PDU 1140. In the example embodiment of FIG. 11, the DFG 1104 includes dataflow nodes 1174a-e. In turn, the dataflow node 1174c (e.g., a filtering node) of the DFG 1104 may include the machine code instructions 1176a1-3; likewise, the dataflow node 1174d (e.g., a join node) of the DFG 1104 may include the machine code instructions 1176b1-3 for non-limiting examples. According to an example embodiment, the machine code instruction 1176a3 (e.g., an evaluate instruction) of the dataflow node 1174c may be mapped to a vector unit 1178a of the PDU 1140, which may also include a scanner unit 1178b, parser unit 1178c, crypter unit 1178d, mover unit 1178e, hasher unit 1178f, and compressor unit 1178g, for non-limiting examples. Similarly, in another example embodiment, the machine code instruction 1176b3 (e.g., a join instruction) of the dataflow node 1174d may be mapped to the hasher unit 1178f of the PDU 1140.

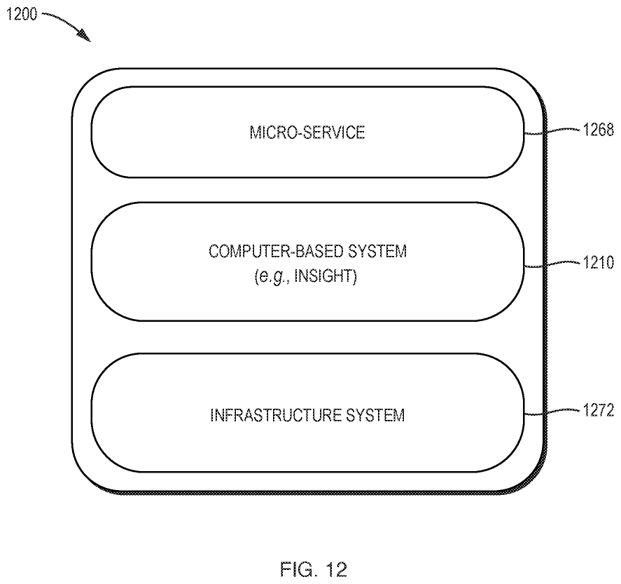

FIG. 12 is a block diagram of an example embodiment of an architecture 1200 for a computer-based system disclosed herein. With reference to FIG. 12, the architecture 1200 includes a micro-service 1268, computer-based system 1210, and infrastructure system 1272. In an example embodiment, the micro-service 1268 may provide an API endpoint for the computer-based system 1210, such as a Hypertext Transfer Protocol (HTTP) or GraphQL endpoint for non-limiting examples. Other endpoint types known to those of skill in the art are also suitable.

According to an example embodiment, the computer-based system 1210 may include a DFG executor, e.g., the VM 130 (FIG. 1A), that, for instance, lays out DFG(s), e.g., DFG(s) 104 (FIG. 1A), 604 (FIG. 6), 704a-b (FIG. 7), or 904a-c (FIG. 9). The DFG executor, e.g., 130, may also spawn and monitor tasks (e.g., processes/subprocesses or threads). Further, in an example embodiment, the computer-based system 1210 may interpret compute nodes, including, for instance, via a hardware PDU, e.g., executor 140 (FIG. 1A), 240 (FIG. 2), 540 (FIG. 5), or 640 (FIG. 6). To continue, according to an example embodiment, the infrastructure system 1272 may provide features and functionality, such as high-performance network protocol stacks (e.g., TLS (transport layer security)/HTTP), which may include, for instance, zero copy, high performance storage access, and a high-performance task scheduler, which may, for instance, be Quality of Service (QOS) controlled for non-limiting example.

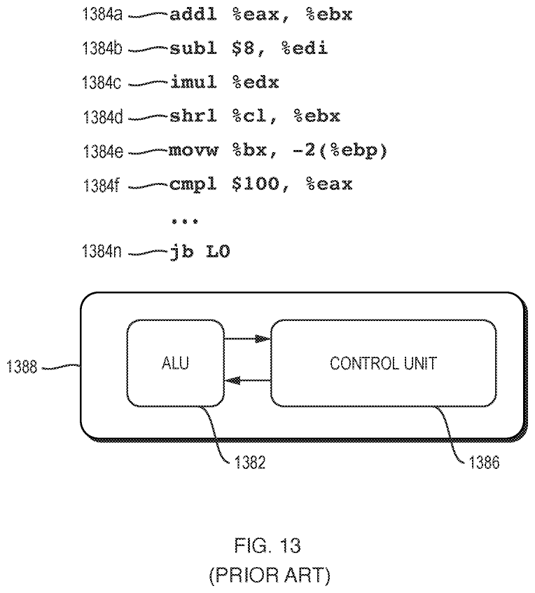

FIG. 13 is a block diagram of an example prior art CPU 1388 in operation. As shown in FIG. 13, the prior art CPU 1388 includes an ALU 1382 and a control unit 1386. The ALU 1382 of prior art CPU 1388 may execute instructions in an ALU-centric ISA, e.g., prior art ALU instructions 1384a-n. According to existing approaches, VM instructions, e.g., instructions 1384a-n, are ALU centric, which makes it easy for JIT compilers to generate code for CPUs, e.g., prior at CPU 1388, where an ALU, e.g., prior art ALU 1382, is the workhorse.

FIG. 14 is a block diagram of an example embodiment of a PDU 1440 in operation. As shown in FIG. 14, according to an example embodiment, the PDU 1440 includes a control unit 1421 and accelerator units 1478a (e.g., a scanner unit), 1478b (e.g., a parser unit), 1478c (e.g., a mover unit), and 1478n (e.g., a vector processing unit). In another example embodiment, accelerator units 1478a-n may be hardware-based units. According to an example embodiment, compute nodes may be programmable using an instruction set that is accelerator-centric, e.g., with instructions 1476a-n, 1176a1-3 (FIG. 11), 1176b1-3 (FIG. 11), 1076a1-3 (FIG. 10), or 1076b1-3 (FIG. 10). Unlike existing approaches, such as using the prior art CPU 1388 and prior art ALU-centric instructions 1384a-n of FIG. 13, an ISA according to an example embodiment may be designed to be accelerator-centric instead, thus, enabling efficient implementation of an accelerator unit, e.g., 1478a-n, for a given function in an instruction, e.g., 1476a-n. An ISA according to an example embodiment may be extensible and evolve as workload requirements change over time.

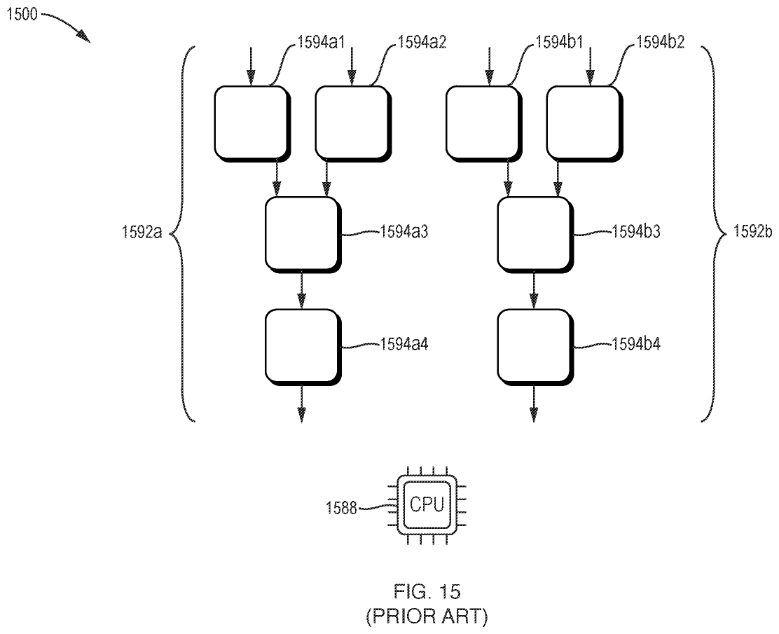

FIG. 15 is a block diagram of an example prior art control flow process 1500 for a prior art CPU 1588. As shown in FIG. 15, the prior art process 1500 may include execution threads 1592a and 1592b which, in turn, may include sequences of statement blocks 1594a1-4 and 1594b1-4, respectively, for potential execution by the prior art CPU 1588. According to conventional approaches, the prior art control flow process 1500 may define an explicit order or sequence in which statements, e.g., blocks 1594a1-4 and 1594b1-4, are executed or evaluated. For example, the prior art thread 1592a may follow a predefined sequence of executing block 1594a1 or 1594a2, followed by executing blocks 1594a3 and 1594a4; likewise, the prior art thread 1592b may follow a predefined sequence of executing block 1594b1 or 1594b2, followed by executing blocks 1594b3 and 1594b4. With existing techniques, data may follow the flow of the prior art process 1500, but the handling of data is secondary to and follows the expressly defined order of execution flow in the prior art process 1500.

FIG. 16 is a block diagram of an example embodiment of a dataflow process 1600 for a PDU 1640. According to the example embodiment of FIG. 16, the dataflow process 1600 may employ DFG 1604 having input node 1674a, compute nodes 1674b-d, and output nodes 1674e-f, which dataflow nodes 1674a-f may be connected variously by edges 1696a-f. In another example embodiment, the input node 1674a may push data into the DFG 1604 while the output nodes 1674e-f may pull data from the DFG 1604. Further, according to yet another example embodiment, the compute nodes 1674b-d may perform transformations or computations on data, which may flow along the edges 1696a-f. Unlike existing approaches, such as the prior art control flow process 1500 of FIG. 15, in an example embodiment, the dataflow process 1600 of FIG. 16 may abstract over explicit control flow by prioritizing routing and transformation of data, e.g., via the dataflow nodes 1674a-f and connecting edges 1696a-f. According to another example embodiment, in the dataflow process 1600, control may follow data and computations may be executed implicitly based on data availability.

### Dataflow Graph (DFG)

FIG. 17 is a block diagram of an example embodiment of a DFG 1704. According to the example embodiment of FIG. 17, the DFG 1704 includes dataflow nodes 1774a-j and edges 1796a-h. In another example embodiment, the nodes 1774a-j may perform operations (i.e., on data) and the edges 1796a-h may carry data across the nodes 1774a-j. Further, in another example embodiment, the edges 1796a-h may move data as stream(s) of data block(s) (not shown). In an example embodiment, all data blocks may be immutable and shared by multiple nodes, e.g., nodes 1774a-j, using reference counts. According to another example embodiment, there may be three different kinds of nodes: input nodes (e.g., 1774a-b), output nodes (e.g., 1774i-j), and compute nodes (e.g., 1774c-h) for non-limiting example. Further, in another example embodiment, input nodes, e.g., 1774a-b, may act as data-sources and output nodes, e.g., 1774i-j, may act as data-sinks. In an example embodiment, input nodes, e.g., 1774a-b, may pull data from local or external sources (not shown) and push the data into a DFG, e.g., 1704. According to another example embodiment, output nodes, e.g., 1774i-j, may pull data from a DFG, e.g., 1704, and push the data to local or external sinks (not shown). Further, in yet another example embodiment, compute nodes, e.g., 1774c-h, may perform various transformations on data such as filtering, grouping, joining, etc., for non-limiting examples, using hardware accelerators on a PDU (not shown). In an example embodiment, a task (e.g., a process/subprocess or thread) may be spawned for each node 1774a-j and edge 1796a-h. According to another example embodiment, each such task may run or execute in parallel.

### Edge

FIG. 18 is a block diagram of an example embodiment of a logical structure of an edge 1896. As shown in FIG. 18, according to an example embodiment, the edge 1896, which may be included in a DFG, e.g., DFG 104 (FIG. 1A), 604 (FIG. 6), 704a-b (FIG. 7), 904a-c (FIG. 9), 1004 (FIG. 10), 1104 (FIG. 11), 1604 (FIG. 16), or 1804 (FIG. 17), may be a task (e.g., a process/subprocess or thread) that pulls data block(s) from an input source node, e.g., input node 1074a (FIG. 10), 1174a-b (FIG. 11), 1674a (FIG. 16), or 1774a-b (FIG. 17), and pushes data into output destination node(s), e.g., output node(s) 1074d (FIG. 10), 1174e (FIG. 11), 1674e-f (FIG. 16), or 1774i-j (FIG. 17). With reference to FIGS. 10, 11, and 16-18, in another example embodiment, the edge 1896 may have a single source input node, e.g., 1074a, 1174a-b, 1674a, or 1774a-b, and can have one or more destination output node(s), e.g., 1074d, 1174e, 1674e-f, or 1774i-j. According to yet another example embodiment, the edge 1896 may have FIFO queue(s) 1898a-c in front of its destination(s) (i.e., endpoint(s) of the edge 1896), which may allow for burst-type processing by compute node(s), e.g., compute node(s) 1074b-c (FIG. 10), 1174c-d (FIG. 11), 1674b-d (FIG. 16), or 1774c-h (FIG. 17). In an example embodiment, FIFO queue(s) 1898a-c may be sized, programmably. According to another example embodiment, the FIFO queue(s) 1898a-c may also help in flow control, for instance, if a FIFO, e.g., 1898a, 1898b, or 1898c, in front of a particular destination node, e.g., the compute node 1074b-c, 1174c-d, 1674b-d, or 1774c-h, is full, then the edge task 1896 may stall until that node makes space in its FIFO. Further, in yet another example embodiment, all data block(s) moving across the edge 1896 may have the same data type.

### Input Node

In an example embodiment, an input node, e.g., input node 1074a (FIG. 10), 1174a-b (FIG. 11), 1674a (FIG. 16), or 1774a-b (FIG. 17), may pull data from local or external source(s), e.g., data source 106 (FIG. 1A), 206 (FIG. 2), 306 (FIG. 3), 506 (FIG. 5), 606 (FIG. 6), or 706 (FIG. 7), and push the data into a DFG, e.g., DFG 104 (FIG. 1A), 604 (FIG. 6), 704a-b (FIG. 7), 904a-c (FIG. 9), 1004 (FIG. 10), 1104 (FIG. 11), 1604 (FIG. 16), or 1804 (FIG. 17), for processing. According to another example embodiment, an input node, e.g., 1074a, 1174a-b, 1674a, or 1774a-b, may have an in-degree of zero and an out-degree of n, where 1≤n≤256 for non-limiting example. Further, in another example embodiment, external sources can be, for instance, databases, key-value stores, or distributed filesystems, etc., such as PostgreSQL, MySQL®, Amazon S3, RocksDB, Redis®, Apache HDFS (Hadoop® Distributed File System) for non-limiting examples, or any other suitable known storage system. With reference to FIGS. 10, 11, 16, and 17, in an example embodiment, an input node, e.g., 1074a, 1174a-b, 1674a, or 1774a-b, can also parse incoming data and extract only necessary fields from it. For instance, according to another example embodiment, an input node, e.g., 1074a, 1174a-b, 1674a, or 1774a-b, can parse data in formats such as JSON (JavaScript Object Notation), Apache Parquet®, or any other suitable known format, and extract only the useful columns from it. In yet another example embodiment, a user may provide configuration parameter(s) for an input node, e.g., 1074a, 1174a-b, 1674a, or 1774a-b, including a location configuration parameter and/or a schema configuration parameter, as described hereinbelow for non-limiting examples.

### Location

With reference to FIGS. 10, 11, 16, and 17, according to an example embodiment, a location configuration parameter may specify for an input node, e.g., 1074a, 1174a-b, 1674a, or 1774a-b, where to fetch data from and/or what protocol to use. Table 1 below lists non-limiting example input data locations and corresponding parameters, if any, for each location, according to an example embodiment. In another example embodiment, if a “full_path” parameter refers to or includes a directory tree that, in turn, contains multiple subdirectories, then an accompanying “partition” parameter may be used to identify parts of the directory tree for processing. By way of non-limiting example, a naming convention for subdirectories may use months of the year, e.g., “Jan”, “Fcb”, “Mar”, etc., or any other suitable naming convention.

TABLE 1
Example supported input data sources

| LOCATION | PARAMETER | DESCRIPTION |
|---|---|---|
| Local File | full_path | Full path of file |
| | partition | List of partitions |
| Local Dir | full_path | Full path of directory |
| | partition | List of partitions |
| S3 | access_token | Access token to read S3 |
| | secret_token | Secret token to read S3 |
| | bucket | Bucket to read |
| | key | Key to read |
| Odbc | connection_string | ODBC (Open Database |
| | | Connectivity) |
| | | connection string |
| Hdfs | address | HDFS named node |
| | | address |
| | path | Directory or File path |
| Peer | address | Peer node's address |
| Cache | address | Address of the cache |
| | | (default is local) |
| | key | Key to lookup |
| Generate:Sequential | type | Data type of |
| | | generated data |
| | count | Number of fields |
| | | to generate |
| | start | Starting number |
| | step | Step value |
| Generator:Random | type | Data type of |
| | | generated data |
| | count | Number of fields |
| | | to generate |
| | seed | Seed, if randomly |
| | | generated |
| Garbage | count | Number of fields |
| | | to generate |

### Schema

In an example embodiment, a schema configuration parameter may specify for an input node, e.g., 1074a, 1174a-b, 1674a, or 1774a-b, how to parse input data and/or what fields to extract from the data. Table 2 below lists non-limiting example schema configuration parameters according to an example embodiment.

TABLE 2
Example schema parameters

| PARAMETER | NAME | DESCRIPTION |
|---|---|---|
| Option | Format | Identity |
| | | JSON |
| | | XML (Extensible Markup Language) |
| | | sv (separated values), i.e., values |
| | | separated by a delimiter character |
| | | Apache Parquet |
| | | Custom (tokens, rules) |
| | Ordered | If true, all fields are ordered |
| View | Field Name | Name of the field |
| | Field Type | Data type of the field |

### Output Node

According to an example embodiment, an output node, e.g., output node 1074d (FIG. 10), 1174e (FIG. 11), 1674e-f (FIG. 16), or 1774i-j (FIG. 17), may perform the inverse operation of an input node, i.e., pull data from a DFG, e.g., DFG 104 (FIG. 1A), 604 (FIG. 6), 704a-b (FIG. 7), 904a-c (FIG. 9), 1004 (FIG. 10), 1104 (FIG. 11), 1604 (FIG. 16), or 1804 (FIG. 17), and push the data to local or external sinks, e.g., data source 106 (FIG. 1A), 206 (FIG. 2), 306 (FIG. 3), 506 (FIG. 5), 606 (FIG. 6), or 706 (FIG. 7). With reference to FIGS. 10, 11, 16, and 17, in another example embodiment, an output node, e.g., 1074d, 1174e, 1674e-f, or 1774i-j, may have an in-degree of n, where 1<n≤256 for non-limiting example, and an out-degree of zero. Further, in yet another example embodiment, external sinks can be, for instance, databases, key-value stores, or distributed filesystems, etc., such as PostgreSQL, MySQL, Amazon S3, RocksDB, Redis, Apache HDFS, or any other suitable known storage system. In an example embodiment, an output node, e.g., 1074d, 1174e, 1674e-f, or 1774i-j, can also prepare certain types of files in formats such as JSON, Apache Parquet, or any other suitable known format, before pushing to external sinks. According to another example embodiment, a user may provide configuration parameter(s) for an output node, e.g., 1074d, 1174e, 1674e-f, or 1774i-j, including, for instance, a location configuration parameter and/or a schema configuration parameter, as described hereinbelow for non-limiting examples.

### Location

In an example embodiment, a location configuration parameter may specify for an output node, e.g., 1074d, 1174e, 1674e-f, or 1774i-j, where to push data and/or what protocol to use. According to another example embodiment, locations supported by input nodes, such as described hereinabove in relation to Table 1 for non-limiting examples, may also be supported by output nodes, e.g., 1074d, 1174e, 1674e-f, or 1774i-j.

### Schema

According to an example embodiment, a schema configuration parameter may specify for an output node, e.g., 1074d, 1174e, 1674e-f, or 1774i-j, how to convert data from a DFG, e.g., 104, 604, 704a-b, 904a-c, 1004, 1104, 1604, or 1804, before sending it to an external sink, e.g., 106, 206, 306, 506, 606, or 706. In another example embodiment, a schema format for output nodes may be the same as for input nodes, such as described hereinabove in relation to Table 2 for non-limiting examples.

### Compute Node

FIG. 19 is a block diagram of an example embodiment of a compute node 1974.

According to an example embodiment, the compute node 1974, may perform transformations on incoming data block(s) (not shown) and output the transformed data block(s). In another example embodiment, the compute node 1974 can accept input from input nodes (not shown) or other compute nodes (not shown) and send results to other compute nodes (not shown) or output nodes (not shown). As shown in FIG. 19, in another example embodiment, the compute node 1974 may have an in-degree of m, where 1<m≤256 for non-limiting example, and an out-degree of n, where 1≤n≤256 for non-limiting example. According to yet an example embodiment, the compute node 1974 may be programmable, and users can program the compute node 1974 to compute any general-purpose data transformation(s).

FIG. 20 is a block diagram of an example embodiment of an execution environment 2000 for a compute node, e.g., compute node 1074b-c (FIG. 10), 1174c-d (FIG. 11), 1674b-d (FIG. 16), 1774c-h (FIG. 17), or 1974 (FIG. 19). In an example embodiment, as shown in FIG. 20, the execution environment 2000 may include an input panel 2001, an output panel 2003, a register file 2005, code memory 2007, accelerator(s) or compute unit(s) 2078a, 2078b, 2078c, 2078d, 2078e (e.g., a hasher unit), and 2078n (e.g., a decompressor unit), and a control unit (not shown). According to another example embodiment, the compute unit(s) 2078a-n may be included by a PDU, e.g., execution resource 140 (FIG. 1A), 240 (FIG. 2), 540 (FIG. 5), 640 (FIG. 6), 1040 (FIG. 10), 1140 (FIG. 11), or 1440 (FIG. 14). Further, in yet another example embodiment, a runtime interpreter, e.g., VM interpreter 858 (FIG. 8), may use accelerator(s), e.g., 2078a-n (FIG. 20), to accelerate data processing. Continuing with reference to FIG. 20, according to an example embodiment, data may move in the execution environment 2000 in four directions: (i) from the input panel 2001 to the output panel 2003 (as indicated by arrow 2009a), (ii) from the input panel 2001 to the register file 2005 (as indicated by arrow 2009b), (iii) from the register file 2005 to the register file 2005 (as indicated by arrow 2009c), or (iv) from the register file 2005 to the output panel 2003 (as indicated by arrow 2009d).

### Input Panel

Continuing with reference to FIG. 20, in another example embodiment, the input panel 2001 may manage the data coming from input edge(s), e.g., 2096a1-6 for non-limiting examples. According to yet another example embodiment, the input panel 2001 may, among other things, control data block queueing, detect an end of stream (eos), etc., for non-limiting examples.

### Output Panel

Continuing with reference to FIG. 20, in an example embodiment, the output panel 2003 may manage data going out from the compute node, such as via output edge(s), e.g., 2096b1-6 for non-limiting examples. According to another example embodiment, the output panel 2003 may, among other things, control data block queueing, send an eos, etc., for non-limiting examples.

### Register File

Continuing with reference to FIG. 20, in yet another example embodiment, the register file 2005 may be used to store a context of the compute node, e.g., temporary results during processing of data blocks. According to an example embodiment, the register file 2005 may include 256 registers, e.g., registers 2011a-n, and each register may be 64-bit wide, for non-limiting examples. However, any suitable number of registers may be used, and registers may be of any suitable size. In another example embodiment, each register content may have a type 2013 associated with it. Table 3 below lists non-limiting example predefined registers and their content.

TABLE 3
Example predefined registers

| | | DATA | |
|---|---|---|---|
| REGISTER | NAME | TYPE | DESCRIPTION |
| r₀ | ZERO | Any(64) | Reads return zero, |
| | | | writes are ignored |
| r₁ | FLAGS | BIT(64) | Contains result of |
| | | | compare instruction |
| r₂-r₇ | | | Reserved |

Table 4 below shows a non-limiting example definition of the FLAGS register.

TABLE 4
Example FLAGS register definition

| | | | |
|---|---|---|---|
| UNUSED[63:3] | GREATER[2] | EQUAL[1] | LESSER[0] |

According to yet another example embodiment, the LESSER, EQUAL, and/or GREATER bits may be set during a compare instruction.

### Code

Continuing with reference to FIG. 20, in an example embodiment, the code memory 2007 may include VM instructions 2076a-n to be executed as part of performing the compute node's function. According to another example embodiment, the code memory 2007 may be arbitrarily long, limited only by available memory. Further, in yet another example embodiment, the code memory 2007 may be divided into three non-limiting example sections as given below in Table 5.

TABLE 5
Example code memory sections

| SECTION | DESCRIPTION |
|---|---|
| Setup | Runs when the compute node is constructed |
| Cleanup | Runs when the compute node is destroyed |
| Main | Main function of the compute node |

### Instruction Set Architecture (ISA)

Continuing with reference to FIG. 20, in an example embodiment, the compute node programs may be written using an accelerator-centric ISA, which may include control flow, map, reduce, generate instructions, etc., for non-limiting examples. According to another example embodiment, compute-intensive map, reduce and/or generate instructions may be implemented either on a PDU, e.g., execution resource 140 (FIG. 1A), 240 (FIG. 2), 540 (FIG. 5), 640 (FIG. 6), 1040 (FIG. 10), 1140 (FIG. 11), or 1440 (FIG. 14), or in software using vector processing accelerators such Intel® AVX (Advanced Vector Extensions)-512, GPUs, e.g., 762n (FIG. 7) or 962n (FIG. 9), or any other suitable known accelerator. Further, in yet another example embodiment and with reference to FIG. 20, program branches may be relative to the program counter (PC) 2015 and can be forward branches and/or backward branches.

### Instruction Categories

Continuing with reference to FIG. 20, in an example embodiment, the VM instructions 2076a-n may be categorized based on the type of control and/or movement of data within the compute node. According to another example embodiment, this may help the VM interpreter 858 in improving instruction-level parallelism where possible. Table 6 below lists non-limiting example supported instruction categories.

TABLE 6
Example instruction categories

| CATE- | | DATA | |
|---|---|---|---|
| GORY | NAME | MOVEMENT | DESCRIPTION |
| 0 | CONTROL_INPUT | Within input | Input panel |
| | | panel | instructions like |
| | | | drain, drop etc. |
| 1 | CONTROL_CODE | Within code | Control flow |
| | | | instructions like |
| | | | branch, done etc. |
| 2 | SCALAR | Within | Register file |
| | | register file | instructions like |
| | | | reset, clear etc. |
| 3 | CONTROL_OUTPUT | Within output | Output panel |
| | | panel | instructions like |
| | | | flush etc. |
| 4 | REDUCE | Input to | Reduce functions |
| | | register file | like sum, min, |
| | | | max etc. |
| 5 | MAP | Input to output | Map functions |
| | | | like add, sub etc. |
| 6 | LOAD | Code to | Register file |
| | | register | initialization |
| | | | functions |
| | | | like load |
| 7 | GENERATE | Register to | Generate |
| | | output | functions like |
| | | | seq etc. |
| 8 | CONTROL_REGISTER | Register to | Clearing register |
| | | register | file etc. |

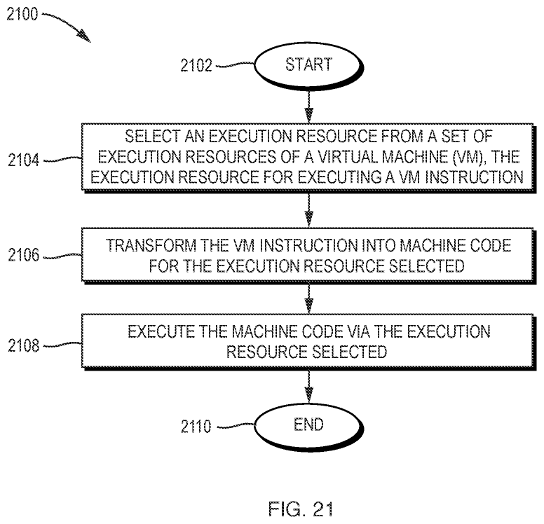

FIG. 21 is a flow diagram of an example embodiment of a computer-implemented method 2100. The method begins (2102) and comprises selecting an execution resource from a set of execution resources of a virtual machine (VM), the execution resource for executing a VM instruction (2104). The method further comprises transforming the VM instruction into machine code for the execution resource selected (2106). The method further comprises executing the machine code via the execution resource selected (2108). The executing 2108 furthers execution by the VM of a dataflow graph that includes at least one compute node. A compute node of the at least one compute node has a set of VM instructions including the VM instruction. The dataflow graph corresponds to at least a portion of a computation workload associated with a user data query. An output of the execution of the dataflow graph: (i) represents a result of processing the at least a portion of the computation workload and (ii) contributes to a response to the user data query. The method thereafter ends (2110) in the example embodiment.

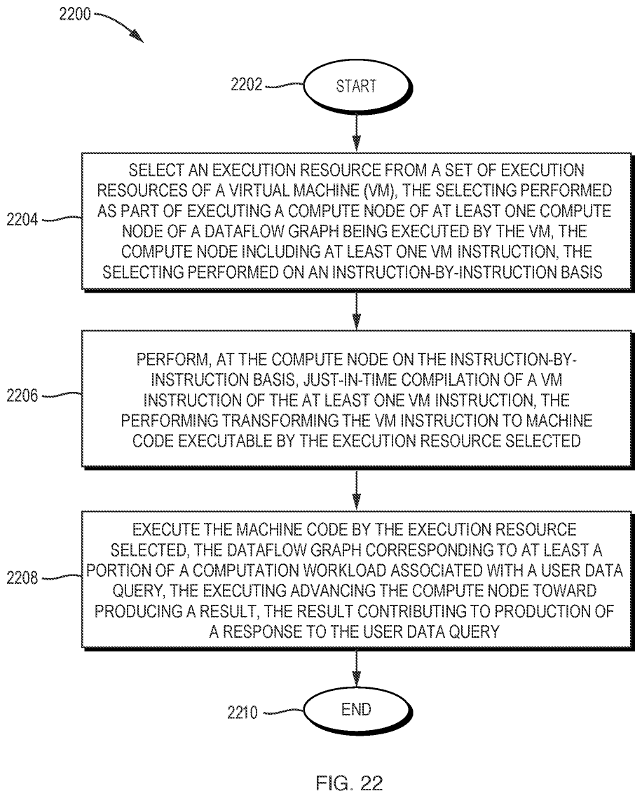

FIG. 22 is a flow diagram of another example embodiment of a computer-implemented method 2200. The method begins (2202) and comprises selecting an execution resource from a set of execution resources of a virtual machine (VM), the selecting performed as part of executing a compute node of at least one compute node of a dataflow graph being executed by the VM, the compute node including at least one VM instruction, the selecting performed on an instruction-by-instruction basis (2204). The method further comprises performing, at the compute node on the instruction-by-instruction basis, just-in-time compilation of a VM instruction of the at least one VM instruction, the performing transforming the VM instruction to machine code executable by the execution resource selected (2206). The method further comprises executing the machine code by the execution resource selected, the dataflow graph corresponding to at least a portion of a computation workload associated with a user data query, the executing advancing the compute node toward producing a result, the result contributing to production of a response to the user data query (2208). The method thereafter ends (2210) in the example embodiment.

FIG. 23 is a block diagram of an example embodiment of an internal structure of a computer 2300 in which various embodiments of the present disclosure may be implemented. The computer 2300 contains a system bus 2352, where a bus is a set of hardware lines used for data transfer among the components of a computer or digital processing system. The system bus 2352 is essentially a shared conduit that connects different elements of a computer system (e.g., processor, disk storage, memory, input/output ports, network ports, etc.) that enables the transfer of information between the elements. Coupled to the system bus 2352 is an I/O device interface 2354 for connecting various input and output devices (e.g., keyboard, mouse, displays, printers, speakers, etc.) to the computer 2300. A network interface 2356 allows the computer 2200 to connect to various other devices attached to a network (e.g., global computer network, wide area network, local area network, etc.). Memory 2358 provides volatile or non-volatile storage for computer software instructions 2360 and data 2362 that may be used to implement embodiments (e.g., the method 2200, method 2100, execution environment 2000, compute node 1974, edge 1896, dataflow process 1600, PDU 1440, architecture 1200, process 900, third phase 800, data analytics stack 700, process 600, server 580, server 470, platform 360, system 200, cluster 100, and computer-based system 110, etc.) of the present disclosure, where the volatile and non-volatile memories are examples of non-transitory media. Disk storage 2364 provides non-volatile storage for computer software instructions 2360 and data 2362 that may be used to implement embodiments (e.g., the method 2200, method 2100, execution environment 2000, compute node 1974, edge 1896, dataflow process 1600, PDU 1440, architecture 1200, process 900, third phase 800, data analytics stack 700, process 600, server 580, server 470, platform 360, system 200, cluster 100, and computer-based system 110, etc.) of the present disclosure. A central processor unit 2366 is also coupled to the system bus 2352 and provides for the execution of computer instructions.

As used herein, the terms “engine” and “unit” may refer to any hardware, software, firmware, electronic control component, processing logic, and/or processor device, individually or in any combination, including without limitation: an application specific integrated circuit (ASIC), a FPGA, an electronic circuit, a processor and memory that executes one or more software or firmware programs, and/or other suitable components that provide the described functionality.

Example embodiments disclosed herein may be configured using a computer program product; for example, controls may be programmed in software for implementing example embodiments. Further example embodiments may include a non-transitory computer-readable medium that contains instructions that may be executed by a processor, and, when loaded and executed, cause the processor to complete methods (e.g., the method 2200, method 2100, etc.) described herein. It should be understood that elements of the block and flow diagrams may be implemented in software or hardware, such as via one or more arrangements of circuitry of FIG. 23, disclosed above, or equivalents thereof, firmware, a combination thereof, or other similar implementation determined in the future.

In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random-access memory (RAM), read-only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer-implemented method comprising:
selecting an execution resource from a set of execution resources of a virtual machine (VM), the execution resource for executing a VM instruction;
transforming the VM instruction into machine code for the execution resource selected; and
executing the machine code via the execution resource selected,
the executing furthering execution by the VM of a dataflow graph including at least one compute node, a compute node of the at least one compute node having a set of VM instructions including the VM instruction, the dataflow graph corresponding to at least a portion of a computation workload associated with a user data query, an output of the execution of the dataflow graph: (i) representing a result of processing the at least a portion of the computation workload and (ii) contributing to a response to the user data query.

2. The computer-implemented method of claim 1, wherein the selecting is based on at least one of: (i) a respective efficiency of executing the VM instruction at each execution resource of the set of execution resources and (ii) a respective availability of each execution resource of the set of execution resources.

3. The computer-implemented method of claim 1, wherein the VM instruction is specified in an instruction set architecture (ISA), wherein the ISA is compatible with at least one type of computation workload, and wherein the at least one type of computation workload includes a type of the computation workload associated with the user data query.

4. The computer-implemented method of claim 3, wherein the at least one type of computation workload includes a Structured Query Language (SQL) query plan, a data ingestion pipeline, an artificial intelligence (AI) or machine learning (ML) workload, a high-performance computing (HPC) program, another type of computation workload, or a combination thereof.

5. The computer-implemented method of claim 1, wherein selecting the execution resource is based on the execution resource including an accelerator.

6. The computer-implemented method of claim 1, wherein selecting the execution resource is based on the execution resource including a programmable dataflow unit (PDU) based accelerator, a graphics processing unit (GPU) based accelerator, a tensor processing core (TPC) based accelerator, a tensor processing unit (TPU) based accelerator, a single instruction multiple data (SIMD) unit based accelerator, a central processing unit (CPU) based accelerator, another type of accelerator, or a combination thereof.

7. The computer-implemented method of claim 1, wherein the compute node is a first compute node, and wherein the computer-implemented method further comprises:
processing, via the first compute node, a first data block associated with the at least a portion of the computation workload, the processing performed in parallel with at least one of: (i) processing, via a second compute node of the at least one compute node, a second data block associated with the at least a portion of the computation workload and (ii) transferring, via an edge of a set of edges associated with the dataflow graph, the second data block associated with the at least a portion of the computation workload.

8. The computer-implemented method of claim 1, further comprising:
controlling a flow of data blocks between at least two dataflow nodes of the dataflow graph, the at least two dataflow nodes including the at least one compute node, the data blocks (i) associated with the at least a portion of the computation workload and (ii) derived from a data source associated with the user data query.

9. The computer-implemented method of claim 1, further comprising:
performing validation of the dataflow graph;
responsive to the validation being unsuccessful, terminating execution of the dataflow graph; and
responsive to the validation being successful, proceeding with the execution of the dataflow graph.

10. The computer-implemented method of claim 1, further comprising:
generating a set of edges associated with the dataflow graph, each edge of the set of edges configured to transfer data blocks between a corresponding pair of dataflow nodes of the dataflow graph, the dataflow nodes including the at least one compute node.

11. The computer-implemented method of claim 10, wherein the generating includes:
configuring an edge of the set of edges to transfer the data blocks using a first in first out (FIFO) queue.

12. The computer-implemented method of claim 11, further comprising configuring, based on a user input, a size of the FIFO queue.

13. The computer-implemented method of claim 10, wherein the generating includes:
configuring an edge of the set of edges to synchronize a first processing speed of a first compute node of the at least one compute node with a second processing speed of a second compute node of the at least one compute node.

14. The computer-implemented method of claim 1, wherein the executing includes:
performing at least one of: an input control function, a flow control function, a register control function, an output control function, a reduce function, a map function, a load function, and a generate function.

15. The computer-implemented method of claim 1, wherein the executing includes:
executing the VM instruction via a software-based execution unit, a hardware-based execution unit, or a combination thereof.

16. The computer-implemented method of claim 1, wherein the dataflow graph includes at least one input node, and wherein the computer-implemented method further comprises:
obtaining, based on an input node of the at least one input node, at least one data block from a data source associated with the user data query.

17. The computer-implemented method of claim 16, wherein the obtaining includes:
implementing a read protocol corresponding to the data source.

18. The computer-implemented method of claim 1, wherein the dataflow graph includes at least one output node, and wherein the computer-implemented method further comprises:
storing, based on an output node of the at least one output node, at least one data block to a datastore.

19. The computer-implemented method of claim 18, wherein the storing includes:
implementing a write protocol corresponding to the datastore.

20. The computer-implemented method of claim 1, further comprising:
spawning at least one task corresponding to at least one of: (i) the at least one compute node, (ii) at least one input node of the dataflow graph, (iii) at least one output node of the dataflow graph, and (iv) at least one edge associated with the dataflow graph.

21. The computer-implemented method of claim 20, wherein a task of the at least one task spawned includes a thread corresponding to the compute node, and wherein the computer-implemented method further comprises:
executing the set of VM instructions via the thread.

22. The computer-implemented method of claim 20, further comprising monitoring execution of a task of the at least one task spawned.

23. The computer-implemented method of claim 1, further comprising:
adapting the set of VM instructions based on at least one statistic associated with the at least a portion of the computation workload.

24. The computer-implemented method of claim 23, wherein a statistic of the least one statistic includes a runtime statistical distribution of data values in a data source associated with the user data query.

25. The computer-implemented method of claim 24, wherein the adapting is responsive to identifying a mismatch between the runtime statistical distribution of the data values and an estimated statistical distribution of the data values.

26. The computer-implemented method of claim 23, wherein the adapting includes at least one of: (i) reordering at least two VM instructions of the set of VM instructions, (ii) removing at least one VM instruction from the set of VM instructions, (iii) adding at least one VM instruction to the set of VM instructions, and (iv) modifying at least one VM instruction of the set of VM instructions.

27. The computer-implemented method of claim 1, further comprising:
generating, based on the dataflow graph, a plurality of dataflow subgraphs; and
configuring at least two dataflow subgraphs of the plurality of dataflow subgraphs to, when executed via the VM, perform a data movement operation in parallel.

28. The computer-implemented method of claim 27, wherein the VM is a first VM, and wherein the data movement operation includes at least one of: (i) streaming data from a data source associated with the user data query and (ii) transferring data to or from a second VM.

29. A computer-based system comprising:
at least one virtual machine (VM);
at least one processor; and
a memory with computer code instructions stored thereon, the at least one processor and the memory, with the computer code instructions, configured to cause a VM of the at least one VM to:
select an execution resource from a set of execution resources of the VM, the execution resource for executing a VM instruction;
transform the VM instruction into machine code for the execution resource selected; and
execute the machine code via the execution resource selected to further execution by the VM of a dataflow graph including at least one compute node, a compute node of the at least one compute node having a set of VM instructions including the VM instruction, the dataflow graph corresponding to at least a portion of a computation workload associated with a user data query, an output of the execution of the dataflow graph: (i) representing a result of processing the at least a portion of the computation workload and (ii) contributing to a response to the user data query.

30. The computer-based system of claim 29, further comprising at least one system resource set, each system resource set of the at least one system resource set associated with a respective VM of the at least one VM.

31. The computer-based system of claim 30, wherein a system resource set of the at least one system resource set includes at least one of: a PDU resource, a GPU resource, a memory resource, a network resource, another type of resource, or a combination thereof.

32. The computer-based system of claim 29, wherein the at least one processor and the memory, with the computer code instructions, are further configured to cause the VM to:
select the execution resource based on at least one of: (i) a respective efficiency of executing the VM instruction at each execution resource of the set of execution resources and (ii) a respective availability of each execution resource of the set of execution resources.

33. The computer-based system of claim 29, wherein the VM instruction is specified in an instruction set architecture (ISA), wherein the ISA is compatible with at least one type of computation workload, and wherein the at least one type of computation workload includes a type of the computation workload associated with the user data query.

34. The computer-based system of claim 33, wherein the at least one type of computation workload includes a Structured Query Language (SQL) query plan, a data ingestion pipeline, an artificial intelligence (AI) or machine learning (ML) workload, a high-performance computing (HPC) program, another type of computation workload, or a combination thereof.

35. The computer-based system of claim 29, wherein the at least one processor and the memory, with the computer code instructions, are further configured to cause the VM to:
select the execution resource based on the execution resource including an accelerator.

36. The computer-based system of claim 29, wherein the at least one processor and the memory, with the computer code instructions, are further configured to cause the VM to:
select the execution resource based on the execution resource including a programmable dataflow unit (PDU) based accelerator, a graphics processing unit (GPU) based accelerator, a tensor processing core (TPC) based accelerator, a tensor processing unit (TPU) based accelerator, a single instruction multiple data (SIMD) unit based accelerator, a central processing unit (CPU) based accelerator, another type of accelerator, or a combination thereof.

37. The computer-based system of claim 29, wherein the compute node is a first compute node, and wherein the at least one processor and the memory, with the computer code instructions, are further configured to cause the VM to, in parallel:
process, via the first compute node, a first data block associated with the at least a portion of the computation workload; and
perform at least one of: (i) processing, via a second compute node of the at least one compute node, a second data block associated with the at least a portion of the computation workload and (ii) transferring, via an edge of a set of edges associated with the dataflow graph, the second data block associated with the at least a portion of the computation workload.

38. The computer-based system of claim 29, wherein the at least one processor and the memory, with the computer code instructions, are further configured to cause the VM to:
control a flow of data blocks between at least two dataflow nodes of the dataflow graph, the at least two dataflow nodes including the at least one compute node, the data blocks (i) associated with the at least a portion of the computation workload and (ii) derived from a data source associated with the user data query.

39. The computer-based system of claim 29, wherein the at least one processor and the memory, with the computer code instructions, are further configured to cause the VM to:
perform validation of the dataflow graph;
responsive to the validation being unsuccessful, terminate execution of the dataflow graph; and
responsive to the validation being successful, proceed with the execution of the dataflow graph.

40. The computer-based system of claim 29, wherein the at least one processor and the memory, with the computer code instructions, are further configured to cause the VM to:
generate a set of edges associated with the dataflow graph, each edge of the set of edges configured to transfer data blocks between a corresponding pair of dataflow nodes of the dataflow graph, the dataflow nodes including the at least one compute node.

41. The computer-based system of claim 40, wherein the at least one processor and the memory, with the computer code instructions, are further configured to cause the VM to:
configure an edge of the set of edges to transfer the data blocks using a first in first out (FIFO) queue.

42. The computer-based system of claim 41, wherein the at least one processor and the memory, with the computer code instructions, are further configured to cause the VM to:
configure, based on a user input, a size of the FIFO queue.

43. The computer-based system of claim 40, wherein the at least one processor and the memory, with the computer code instructions, are further configured to cause the VM to:
configure an edge of the set of edges to synchronize a first processing speed of a first compute node of the at least one compute node with a second processing speed of a second compute node of the at least one compute node.

44. The computer-based system of claim 29, wherein the at least one processor and the memory, with the computer code instructions, are further configured to cause the VM to:
execute the machine code by performing at least one of: an input control function, a flow control function, a register control function, an output control function, a reduce function, a map function, a load function, and a generate function.

45. The computer-based system of claim 29, wherein the at least one processor and the memory, with the computer code instructions, are further configured to cause the VM to:
execute the VM instruction via a software-based execution unit, a hardware-based execution unit, or a combination thereof.

46. The computer-based system of claim 29, wherein the dataflow graph includes at least one input node, and wherein the at least one processor and the memory, with the computer code instructions, are further configured to cause the VM to:
obtain, based on an input node of the at least one input node, at least one data block from a data source associated with the user data query.

47. The computer-based system of claim 46, wherein the at least one processor and the memory, with the computer code instructions, are further configured to cause the VM to:
obtain the at least one data block by implementing a read protocol corresponding to the data source.

48. The computer-based system of claim 29, wherein the dataflow graph includes at least one output node, and wherein the at least one processor and the memory, with the computer code instructions, are further configured to cause the VM to:
storing, based on an output node of the at least one output node, at least one data block to a datastore.

49. The computer-based system of claim 48, wherein the at least one processor and the memory, with the computer code instructions, are further configured to cause the VM to:
store the at least one data block by implementing a write protocol corresponding to the datastore.

50. The computer-based system of claim 29, wherein the at least one processor and the memory, with the computer code instructions, are further configured to cause the VM to:
spawn at least one task corresponding to at least one of: (i) the at least one compute node, (ii) at least one input node of the dataflow graph, (iii) at least one output node of the dataflow graph, and (iv) at least one edge associated with the dataflow graph.

51. The computer-based system of claim 50, wherein a task of the at least one task spawned includes a thread corresponding to the compute node, and wherein the at least one processor and the memory, with the computer code instructions, are further configured to cause the VM to:
execute the set of VM instructions via the thread.

52. The computer-based system of claim 50, computer-based system of claim 50, wherein a task of the at least one task spawned includes a thread corresponding to the compute node, and wherein the at least one processor and the memory, with the computer code instructions, are further configured to cause the VM to:
monitor execution of a task of the at least one task spawned.

53. The computer-based system of claim 29, wherein the at least one processor and the memory, with the computer code instructions, are further configured to cause the VM to:
adapt the set of VM instructions based on at least one statistic associated with the at least a portion of the computation workload.

54. The computer-based system of claim 53, wherein a statistic of the least one statistic includes a runtime statistical distribution of data values in a data source associated with the user data query.

55. The computer-based system of claim 54, wherein the at least one processor and the memory, with the computer code instructions, are further configured to cause the VM to:
adapt the set of VM instructions responsive to identifying a mismatch between the runtime statistical distribution of the data values and an estimated statistical distribution of the data values.

56. The computer-based system of claim 53, wherein the at least one processor and the memory, with the computer code instructions, are further configured to cause the VM to:
adapt the set of VM instructions by performing at least one of: (i) reordering at least two VM instructions of the set of VM instructions, (ii) removing at least one VM instruction from the set of VM instructions, (iii) adding at least one VM instruction to the set of VM instructions, and (iv) modifying at least one VM instruction of the set of VM instructions.

57. The computer-based system of claim 29, wherein the at least one processor and the memory, with the computer code instructions, are further configured to cause the VM to:
generate, based on the dataflow graph, a plurality of dataflow subgraphs; and
configure at least two dataflow subgraphs of the plurality of dataflow subgraphs to, when executed via the VM, perform a data movement operation in parallel.

58. The computer-based system of claim 57, wherein the VM is a first VM, and wherein the data movement operation includes at least one of: (i) streaming data from a data source associated with the user data query and (ii) transferring data to or from a second VM.

59. A computer-implemented method comprising:
selecting an execution resource from a set of execution resources of a virtual machine (VM), the selecting performed as part of executing a compute node of at least one compute node of a dataflow graph being executed by the VM, the compute node including at least one VM instruction, the selecting performed on an instruction-by-instruction basis;
performing, at the compute node on the instruction-by-instruction basis, just-in-time compilation of a VM instruction of the at least one VM instruction, the performing transforming the VM instruction to machine code executable by the execution resource selected; and
executing the machine code by the execution resource selected, the dataflow graph corresponding to at least a portion of a computation workload associated with a user data query, the executing advancing the compute node toward producing a result, the result contributing to production of a response to the user data query.
